(19) United States
(12) Patent Application Publication
(10) Pub. No.: US 2024/0334050 A1
(43) Pub. Date: Oct. 3, 2024

(54) DEVICE AND METHOD FOR AUTOMATIC CAMERA TRANSITION

(71) Applicant: SAMSUNG ELECTRONICS CO., LTD., Suwon-si (KR)

(72) Inventors: Liubov Vladimirovna STEPANOVA, Angarsk (RU); Vladimir Petrovich BOGACHEV, Moscow (RU); Maxim Alexeevich SHIKUNOV, Moscow (RU); Aleksandr Aleksandrovich KHAKHMOVICH, Moscow (RU); Kira Sergeevna KIRILLOVA, Moscow Oblast (RU); Petr POHL, Lobnya (RU)

(73) Assignee: SAMSUNG ELECTRONICS CO., LTD., Suwon-si (KR)

(21) Appl. No.: 18/618,759

(22) Filed: Mar. 27, 2024

(30) Foreign Application Priority Data
Mar. 27, 2023 (RU) 2023107262

(51) Int. Cl. H04N 23/667; G06T 7/246; G06T 7/593; H04N 23/61

(52) U.S. Cl. CPC H04N 23/667; G06T 7/246; G06T 7/593; H04N 23/61; G06T 2207/10012

(57) ABSTRACT

According to an embodiment of the disclosure, the method may include obtaining an image of a scene including an object of interest to be tracked in at least one camera mode, obtaining image data of at least two consecutive frames in the at least one camera mode based on the image, estimating a disparity and a reliability of the scene including the object of interest based on the image data, estimating a camera-to-object distance based on the disparity and the reliability, switching the camera mode based on the camera-to-object distance.

### FIELD

The present disclosure relates to methods and devices for automatic camera transition between operation modes (hereinafter referred to as camera transition), when the camera is fixed at an object depending on the distance to the object, and can be used, in particular, for photo and video capturing with smartphone cameras, and in tablet computers running Android, IOS, HarmonyOS and similar systems, as well as in other similar devices which need automatic camera transition.

### BACKGROUND

A variety of camera transition methods are known in the background art, which are currently used by major manufacturers of photo and video equipment, in particular, e.g. switching (transition) between camera modes in a digital camera can be accomplished manually by the user. In some cases, automatic camera transition requires specific hardware such as laser/infrared/radio motion sensors, radars, lidars. In this case, consideration must be given to time required for switching camera modes, and power consumption.

### SUMMARY

According to an embodiment of the disclosure, the method, performed by a device, may include obtaining an image of a scene including an object of interest to be tracked in at least one camera mode.

According to an embodiment of the disclosure, the method may include obtaining image data of at least two consecutive frames in the at least one camera mode based on the image.

According to an embodiment of the disclosure, the method may include estimating a disparity and a reliability of the scene including the object of interest based on the image data.

According to an embodiment of the disclosure, the method may include estimating a camera-to-object distance based on the disparity and the reliability.

According to an embodiment of the disclosure, the method may include switching the camera mode based on the camera-to-object distance.

According to an embodiment of the disclosure, the device may include at least one camera, at least one memory configured to store instructions and at least one processor configured to execute the instructions.

According to an embodiment of the disclosure, the at least one processor is configured to obtain an image of a scene including an object of interest to be tracked in at least one camera mode via the at least one camera.

According to an embodiment of the disclosure, the at least one processor is configured to obtain image data of at least two consecutive frames in the at least one camera mode based on the image.

According to an embodiment of the disclosure, the at least one processor is configured to estimate a disparity and a reliability of the scene including the object of interest based on the image data.

According to an embodiment of the disclosure, the at least one processor is configured to estimate a camera-to-object distance based on the disparity and the reliability.

According to an embodiment of the disclosure, the at least one processor is configured to switch the camera mode based on the camera-to-object distance.

According to an embodiment of the disclosure, the image data may include stereo data.

According to an embodiment of the disclosure, the image data may include a field of at least one motion vector of the object of interest.

### BRIEF DESCRIPTION OF THE DRAWINGS

The above and other features and advantages of the disclosure are explained in the following description illustrated by drawings, in which:

FIG. 1A is a scene image where camera is switched from Ultra Wide to Telephoto camera and vice versa when capturing a distant object.

FIG. 1B is a schematic view of scene viewing angles when camera is switched from Ultra Wide to Telephoto camera and vice versa when capturing a distant object.

FIG. 2A is a scene image when camera is switched from Ultra Wide (wide-angle camera) to Wide (ultra wide-angle camera) and vice versa when capturing a closer object or the whole scene.

FIG. 2B is a schematic view of scene viewing angles when camera is switched from Ultra Wide (wide-angle camera) to Wide (ultra wide-angle camera) and vice versa when capturing a closer object or the whole scene, according to the related art.

FIG. 3A is a scene image when camera is switched from Telephoto camera to Ultra Wide (wide-angle camera) and vice versa, and from Ultra Wide to Wide (ultra wide-angle camera) and vice versa when capturing a scene, with the required focal length to the object changed depending on user demands.

FIG. 3B is a schematic view of scene viewing angles when camera is switched from Telephoto camera mode to Ultra Wide (wide-angle camera) and vice versa, and from Ultra Wide to Wide (ultra wide-angle camera) and vice versa when capturing the scene, with the required focal length to the object changed depending on user demands.

FIG. 4A is a scene image, from which disparity is calculated.

FIG. 4B is a scene depth map resulting from the estimated scene disparity in FIG. 4A.

FIG. 5A is a scene image, from which a scene motion vector field is calculated.

FIG. 5B is a motion vector field based on scene motion data of FIG. 5A.

FIG. 6A is a scene image, from which a scene depth map is generated using data acquired from laser sensors, according to the related art.

FIG. 6B is a scene range image of FIG. 6A, obtained based on data from laser sensors.

FIG. 7A is a flowchart of a method for automatic camera transition from Ultra Wide (wide-angle camera) to Wide (ultra wide-angle camera), according to an embodiment.

FIG. 7B is a flowchart of a method for automatic camera transition from Wide (ultra wide-angle camera) to Ultra Wide (wide-angle camera), according to an embodiment.

FIG. 8A is a scene image when camera application is started in Ultra Wide mode.

FIG. 8B is automatic estimation of motion on the scene, as seen by user on camera.

FIG. 8C is automatic estimation of distance to object of interest, as seen by user on camera.

FIG. 8D is an object image at the operation of analysis of estimations from FIG. 8B, 8C, as seen by user on camera.

FIG. 8E is a scene image at camera transition, as seen by user on camera.

FIG. 9 is an example of a bounding box in the form of 2D grid nodes.

FIG. 10 is a structural diagram of a device for automatic camera transition.

### PREFERRED EMBODIMENTS

Embodiments of the present disclosure will be described in detail below. Embodiments have been illustrated in the accompanying drawings, in which the same or similar reference numerals refer to the same or similar elements, or elements having the same or similar functions. The embodiments described with reference to the accompanying drawings are illustrative, used only to explain the present disclosure, and should not be construed as limiting it in any way.

Reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, “includes”, “including”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Before undertaking the detailed description below, it may be advantageous to set forth definitions of certain words and phrases used throughout the present disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. Similarly, the term “set” means one or more. Accordingly, the set of items may be a single item or a collection of two or more items.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

it should be noted that to capture an object of interest located at a distance from the camera user, a multi-camera system is used, which includes multiple cameras capable of switching between themselves. The cameras can have closer focal lengths (macro camera, wide camera), i.e. cameras for working at closer (short) distance from the object, and longer focal lengths (ultra wide camera, telephoto camera), i.e. cameras for working at greater (long) distance from the object. This disclosure will consider a multi-camera system with at least two cameras having different focal lengths. Camera with a closer focal length will be referred to as Wide camera. Camera with a longer focal length will be referred to as Ultra Wide camera. Switching between the cameras (Wide and Ultra Wide) in the multi-camera system is referred to as transition to Wide and Ultra Wide mode, respectively.

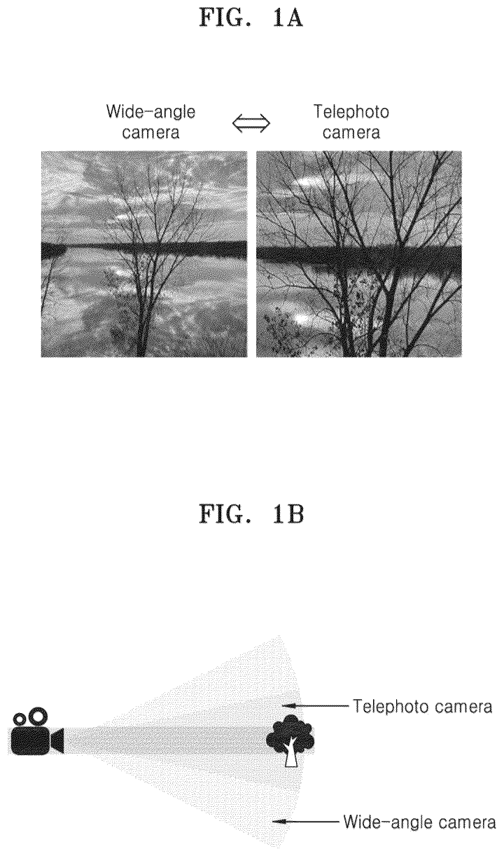

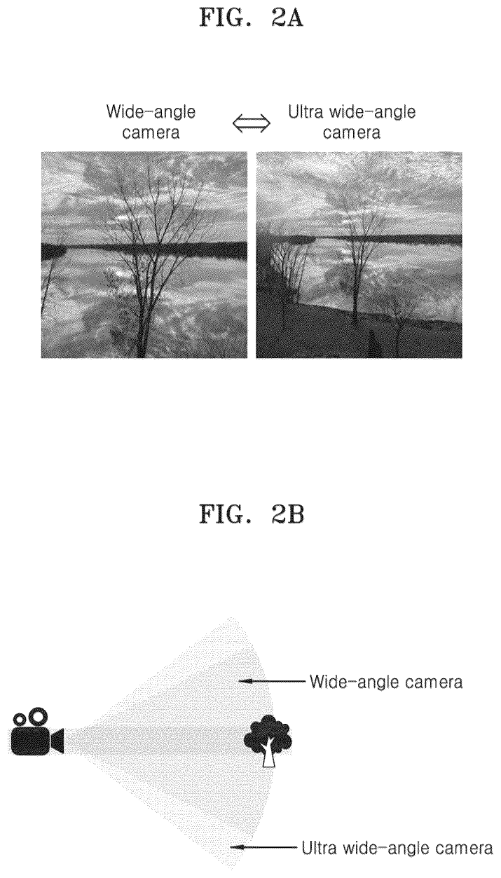

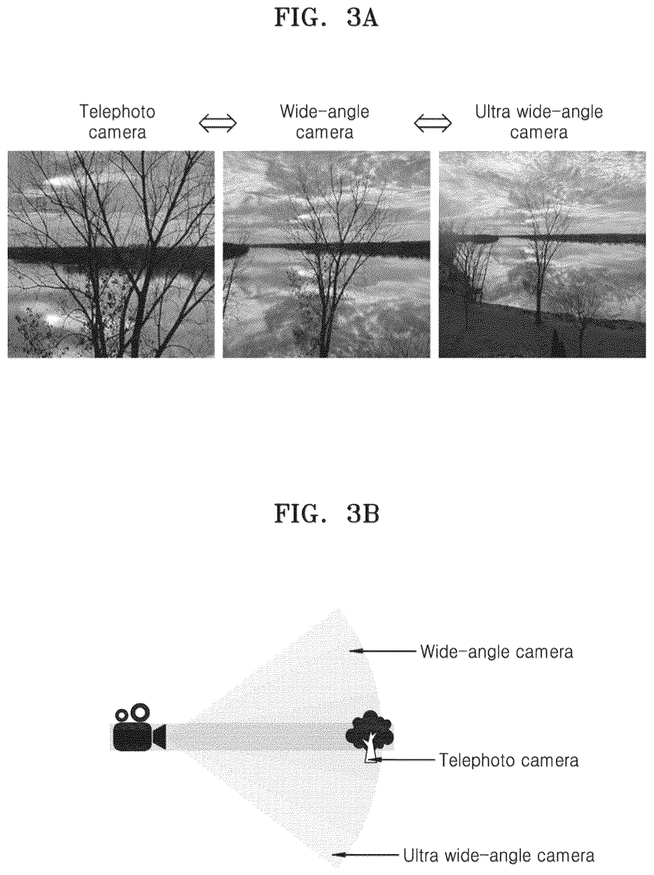

To elucidate the problem solved by the present disclosure, consider typical camera transition cases, such as between Tele (telephoto camera), Ultra Wide and Wide modes, as illustrated in FIGS. 1A, 1B, 2A, 2B and 3A, 3B:
1) transition from Ultra Wide (wide-angle camera) to Tele (telephoto camera) and vice versa when capturing a distant object (see FIG. 1A, 1B),
2) transition from Ultra Wide (wide-angle camera) to Wide (ultra wide-angle camera) and vice versa when capturing a closer object, the most of the object or the whole scene (see FIG. 2A, 2B),
3) transition from Tele (telephoto camera) to Ultra Wide (wide-angle camera) and vice versa, and from Ultra Wide (wide-angle camera) to Wide (ultra wide-angle camera) and vice versa when capturing an object in focus or out of focus, zoom-in or zoom-out according to user's needs (see FIG. 3A, 3B).

It should be noted that the transition from Ultra Wide to Wide and vice versa is more amenable to automation and more popular to the end user.

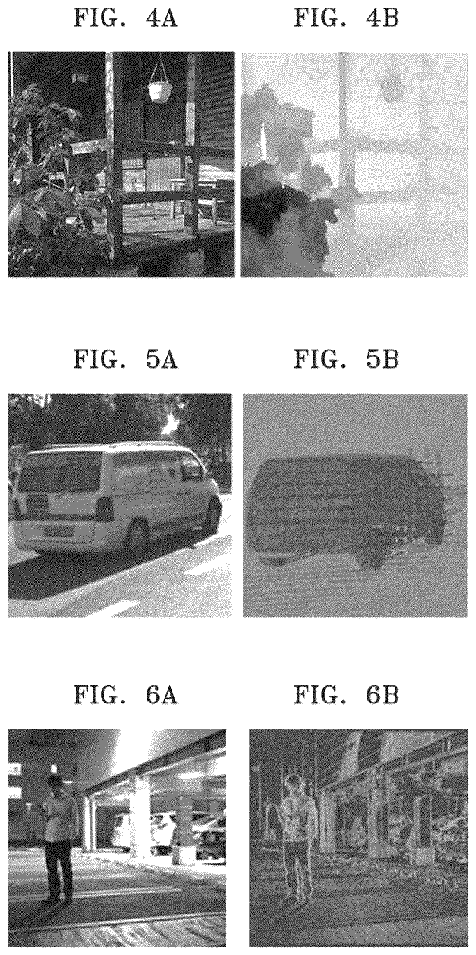

To take decision of automatic camera transition, various methods use additional information obtained from calculations and measurements described below (1), (2) and (3).
(1) Disparity, used to calculate a scene depth map, is one kind of information for taking camera transition decision. Disparity (mismatch or defocusing of scene) is generally calculated from two matching images of the same scene captured from two different angles, e.g. by a dual pixel camera or a stereo camera. FIG. 4A shows a scene to be captured with the camera, and FIG. 4B shows a depth map of the scene of FIG. 4A, used to take camera transition decision.
(2) Camera transition decision can be also taken based on motion data in the scene and consecutive images (frames) from the camera, used to determine the direction of the object of interest and build a field of vectors, and the object direction and speed can be used to calculate the required instant of camera lens switching to improve quality of photos and/or videos. In addition, to compensate for camera movement during capturing based on the camera initial position and direction, current camera position and direction data acquired e.g. from an accelerometer, gyroscope, magnetometer and other motion sensors, commonly integrated into smartphones, can be used. FIG. 5A shows a scene to be captured by camera, and FIG. 5B shows a motion vector field of the scene of FIG. 5A, whereby the decision to switch the camera is taken.
(3) Camera transition decision can be also taken based on scene depth data acquired from laser sensors, including infrared sensors, such as time-of-flight (ToF) sensors or lidars (LiDAR) which are based on determining distance by emitting light from a laser or LED and determining return time of reflected light to the receiver. FIG. 6A shows a scene to be captured by the camera, and FIG. 6B shows a range view of the scene of FIG. 6A, based on which the camera transition decision is taken.

Inventors have studied a variety of solutions on the market and identified main challenges to overcome in a new method and device for automatic camera transition.

Conventional solutions for automatic camera transition require significant time (up to a second) for processing and/or computing information, which in turn delays initiation of camera transition and, accordingly, has bad impact on quality of the image captured with the camera.

One desire is to substantially reduce the camera transition time, which should be almost instantaneous and take a few milliseconds to make the transition process imperceptible to the user.

In addition, conventional automatic camera transition solutions are liable to frequent transition errors when capturing an object, for example, when capturing an object through a window glass or a shop-window, when the sensors used erroneously recognize glass as an object, initiating incorrect camera transition and impairing quality of the image captured by the camera. To overcome this drawback, additional information about the object is added to input, in particular, depth map and motion vector field of the scene containing the object, to take camera transition decision.

Furthermore, conventional camera transition methods and devices often require specific hardware, such as various laser sensors, including infrared sensors e.g. time-of-flight (ToF) sensors or lidars (LiDAR), which are built into cameras, requiring significant power consumption and substantially increasing the cost of the device. However, such power consumption is completely unacceptable for smartphones. The goal of the present method and device is also to reduce energy consumption.

The object of the present method and device is to provide a lightweight, compact, precise device to enable automatic camera transition, preferably to switch the camera between Ultra Wide and Wide mode, when the distance between the camera and an object of interest exceeds a predetermined threshold, using object depth and position information obtained by estimating disparity and tracking data of the object in the scene, as well as data considering movement in the scene of interest, including the object (in particular, motion vector fields). In addition, an embodiment may use additional motion data from an accelerometer, gyroscope, depth sensors or other sensors to obtain a more precise estimate of the object position when the transition decision is taken. When reduction in cost or power consumption is required, or no such sensors are available, the sensors may be omitted without considerable impact on the quality. So the claimed solution is flexible and sustainable.

US20160007008A1 (patentee Apple Inc.), IPC: G03B 13/34, H04N 13/02, publication date 7 Jan. 2016, discloses a mobile camera system, wherein a method of depth information-based autofocusing comprises obtaining two images of the same scene from two cameras with different focal distance, in particular, Wide and Tele. After obtaining information on desired focus on a scene, for example, from the user tapping on the screen, a seamless transition is performed by blending frames from Wide and Tele lenses.

However, the camera requires manual control from the user. The provided method can only be used for capturing zoomed-in photos and videos.

WO2020073959A1 (patentee Huawei Technologies Co Ltd.), IPC H04N 5/232, publication date 16 Apr. 2020, discloses image capturing method and electronic device. This method is based on acquiring the distance information from the distance sensor (i.e. laser and/or infrared sensor). The distance information is then processed and analyzed to determine the appropriate focal distance and to choose one of the modes: Tele, Wide, or Ultra wide.

However, the method has the following drawbacks: additional distance sensor is required for the operation and its incorporation increases the production cost; focusing on the object of interest requires direct participation from user.

U.S. Pat. No. 11,218,641B2 (patentee Qualcomm Inc.), publication date 4 Jan. 2022, IPC H04N 5/225, H04N 5/232 discloses an apparatus and method to capture image data. The method is based on scaling ratio calculation and pixel binning.

When the user-requested scaling level and/or required pixel binning exceeds a camera transition threshold, the transition between cameras with different optical scaling levels and/or different focal lengths, i.e. Wide, Ultra Wide, and Tele, happens. However, the method is manual and doesn't provide automatic camera transition, as user-requested focusing on the object of interest initiates the process, followed by camera transition.

A relevant reference is U.S. Pat. No. 10,291,842 B2 (patentee Samsung Electronic Co Ltd), IPC G06T7/00; H04N 5/225, publication date 14 May 2014, disclosing a photographing camera transition method and digital photographing apparatus. The method is based on obtaining images from wide-angle and telephoto cameras, calculating depth map by stereo matching, and using depth map to obtain motion information. Based on obtained motion information and calculated object speed, transition between Wide and Tele cameras is initiated.

However, the provided method can only be used for capturing zoom-in photos and videos; moreover, two cameras working simultaneously increase power consumption of the apparatus as a whole.

All of the above disclosures do not meet current requirements dictated by electronic portable devices with built-in cameras for capturing video/photos. At the same time, it is very difficult to combine, in state-of-the art electronic devices, the requirements for compactness of the device to be suitable for use in smartphones, with maintaining quality of the captured image in real time, which is ensured by automatic camera transition.

To illustrate advantages of the present method and device for automatic camera transition, a comparative analysis of functionalities of the disclosure and related technical solutions described above is given below.

### The Disclosure

1) provides switching the camera from Ultra Wide mode to Wide mode and vice versa, and can also be used to automatically switch from Telephoto Camera Mode to Ultra Wide mode when the object is lost. Also, embodiments can be used to switch from Ultra Wide and/or Wide mode to Telephoto (macro) mode and vice versa.
2) requires stereo data and image data,
3) direct user control of the camera is not required,
4) utilizes depth data and motion vector field information on the scene containing the object of interest,
5) optionally, can use other data, such as data from various sensors (ToF, LiDAR, UWB, accelerometer, gyroscope and others) to improve accuracy (but they are not obligatory).
   U.S. Pat. No. 10,291,842 B2 (Samsung Electronics Co Ltd) (Related Art)
1) provides switching the camera from Ultra Wide mode to Telephoto Mode and vice versa,
2) requires stereo data from Ultra Wide mode and Telephoto camera,
3) direct user control of the camera is not required,
4) utilizes object's motion information from depth data.

### US20160007008A1 (Patentee Apple Inc.)

1) provides switching the camera from Ultra Wide mode to Telephoto Mode and vice versa,
2) requires stereo data from Ultra Wide mode and Telephoto camera,
3) direct user control of the camera is required to initiate camera transition,
4) utilizes scene depth data.

### WO2020073959A1 (Patent Holder Huawei Technologies Co Ltd.)

1) provides switching the camera from Telephoto camera to Ultra Wide mode and Wide mode and vice versa,
2) requires distance-to-object data from distance sensor,
3) direct user control of the camera is required to initiate camera transition,
4) utilizes data from sensors (laser and/or IR).
   U.S. Pat. No. 11,218,641B2 (Patentee Qualcomm Inc.)
1) provides switching the camera from Telephoto camera to Ultra Wide mode (wide-angle camera) and Wide mode (ultra wide-angle camera) and vice versa,
2) requires stereo data from wide-angle camera, ultra-wide-angle camera and telephoto camera,
3) direct user control of the camera is required to initiate camera transition,
4) utilizes scaling factor calculation.

Within the scope of the disclosure, the following used concepts and terms shall be interpreted as they are defined by the inventors:

Object of Interest is an object chosen by the user to be captured.

Scene is an area chosen by the user, in which an object of interest is located.

Region of Interest (ROI) is a certain area (region) on device screen, selected using “grid” function in photo and video application inherent in state-of-the art smartphones running Android, IOS, etc. operating systems. For example, a device screen may be divided into multiple equal or unequal boxes or other shapes that form a grid. One cell or box of this grid, chosen by the user, is called Region of Interest (ROI). As an example, the inventors considered a screen divided into equal boxes forming 9×13 grid, but this example is not limiting. In this case, there are 9×13 ROIs on the screen.

Selected Region of Interest (Selected ROI) is a region of interest defined based on a user-selected area, which may contain center of the user-selected area, major part of it, or the entire user-selected area, depending on the user demands, when autofocusing on the object. If the user doesn't select the region himself, ROI may be selected automatically. FIG. 2A shows a selected ROI. Selected ROI, as well as its coordinates, is considered as input to start object tracking process.

Current Region of Interest (Current ROI)—on the first frame, current ROI corresponds to selected ROI, while on consecutive frames current ROI is the region of interest returned by the tracker for current frame. User selects ROI only for the first time. It should be noted that each frame is conditionally divided into ROI grid, for example 13×9, at the first iteration, ROI is selected by user input (conditionally, user indicates where object of interest is), then this information is transmitted to tracker, and for each subsequent frame, it is predicted in which ROI from the grid the object will be located.

Multi-camera system is a system comprising at least two cameras that can be switched between each other. Suitable cameras include: a short-range camera such as ultra wide-angle camera; long-range camera such as a wide-angle camera; very short-range camera such as a macro camera, and very long-range camera such as telephoto camera.

Wide mode is a wide camera in multi-camera system. This camera cannot focus at far distance. For example, it can focus at a distance less than 30 cm, but the characteristics may be different.

Ultra Wide mode is a ultra wide camera in multi-camera system. This camera cannot focus at close distance. For example, it can focus at a distance more than 30 cm, but the characteristics may be different.

The disclosure can be used for different cameras in a multi-camera system, but within the scope of the present disclosure, the inventors contemplate camera transition from Wide mode to Ultra Wide mode and vice versa.

Tracker is a sequence of data processing operations, which outputs, based on input of data of current ROI with an object to be captured, data (coordinates) of the object in consecutive frames.

PDAF data is images obtained from light rays reflected from an object within frame and incident on opposite (left and right) sides of camera lens. The object is in focus if two obtained images match. Obtained images are also referred to as left and right image, respectively.

Dual Pixel is a phase autofocus technique that uses each pixel of sensor to detect phase and acquire color information, greatly improving both speed and precision of autofocus compared to conventional systems.

SAD curve is a curve on 2D graph: the X axis corresponds to shift in the number of pixels of left image relative to right one, the Y axis corresponds to sum of pixel-by-pixel differences between images for selected patch; the inventors obtain SAD curves using sensors built into smartphone, which are called “dual pixels” and contain information about two pictures (left and right image of the object from the phone with a slight shift).

Disparity (mismatch) is a scene defocusing value obtained via analysis of SAD curve. Formally, disparity is local minimum on SAD curve, therefore, it is measured in number of pixels.

Special (Predetermined) Camera Use Case is any camera use case different from standard and in which camera transition may be inconsistent, e.g. case of transparent object, reflective object, capture behind glass, camera rotation and movement in Wide mode, very small objects, non-textured objects, non-textured background without an object (white wall case), scenario of walking around the room, out-of-frame object, camera moving away from object, object moving while camera is still.

Standard Camera Use Case—for the purpose of this disclosure, standard case refers to a scenario where user is capturing a medium-size non-transparent and non-reflective 2D or 3D object (having a texture), user with camera enabled in Ultra Wide mode approaches closer to object, moving not too fast or too slow, with uniform speed, and with camera rotated or not. Upon approaching the object at a certain distance set by threshold, camera switches to Wide mode. User takes photo or video. Then the user moves away from the object, and upon moving away at a certain distance set by threshold, camera switches to Ultra Wide mode.

Range Image (Depth Map) is an image formed such that each pixel encodes, instead of color, information about distance between respective point on the scene and camera viewpoint.

Reliability is the extent to which obtained measurement or calculation (e.g. sensor readings, computed image characteristics) is affected by noise, and, hence, to what extent the measurement accuracy can be relied upon. Generally, reliability can be estimated as signal-to-noise ratio by the expression:

$$R = 100 {x}^{\frac{{Y}_{S}}{{Y}_{N}}} , \qquad ( 1 )$$

where R is reliability, Y_{S} is the signal level, and Y_{N} is the noise level.

Examples of calculating reliability for specific measurements or calculations can be found in the following state-of-the art publications:
[1] U.S. Pat. No. 8,068,543B2, IPC H04B 1/66, publication date 29 Nov. 2011;
[2] Liu, Jun & Ye, Ping & Zhang, Xingchen & Xiao, Gang. (2021). Real-time long-term tracking with reliability assessment and object recovery. IET Image Processing. 10.1049/ipr2.12072;
[3] J. Zhu, L. Wang, R. Yang, J. E. Davis and Z. pan, “Reliability Fusion of Time-of-Flight Depth and Stereo Geometry for High Quality Depth Maps,” in IEEE Transactions on Pattern Analysis and Machine Intelligence, vol. 33, no. 7, pp. 1400-1414 July 2011, doi: 10.1109/TPAMI.2010.172.

Bounding Box is a box that bounds the shape of object of interest on scene plane.

Scaling Factor is a factor indicative of change in object size between consecutive frames. By way of example, and not limitation, scaling factor can be computed in terms of aspect ratio of respective bounding boxes of the object; the following documents also describe methods for calculating scaling factor through estimation of motion vectors:
[4] WO2013106425A1, IPC H04N 7/26, publication date 18 Jul. 2013;
[5] Wang H, Shen J, Chen Z, Shen J. A Fast Object Tracking Approach Based on the Motion Vector in a Compressed Domain. International Journal of Advanced Robotic Systems. 2013; 10(1). doi: 10.5772/55210;
[6] Alvar, Saeed & Bajic, Ivan. (2018). MV-YOLO: Motion Vector-Aided Tracking by Semantic Object Detection. 1-5. 10.1109/MMSP.2018.8547125.

Hybrid Estimation of Distance to Object is a method of estimating camera-to-object distance, using different sources of scene depth data for final distance estimate. By way of example, and not limitation, hybrid estimate may use a weighted combination of depth data from different sources (e.g. PDAF data, depth sensors, and motion vectors), and may also be based on selecting the most reliable source of depth data based on reliability estimation.

Transition from Ultra Wide mode to Wide mode is a process of transition from using Ultra Wide camera lens to using Wide camera lens when capturing an image containing a moving object of interest and changing respective optimal focal length range of the camera lens.

Transition Wide mode to Ultra Wide mode is a process of transition from using Ultra Wide camera lens to using Wide camera lens when capturing an image containing a moving object of interest and changing respective optimal focal length range of the camera lens.

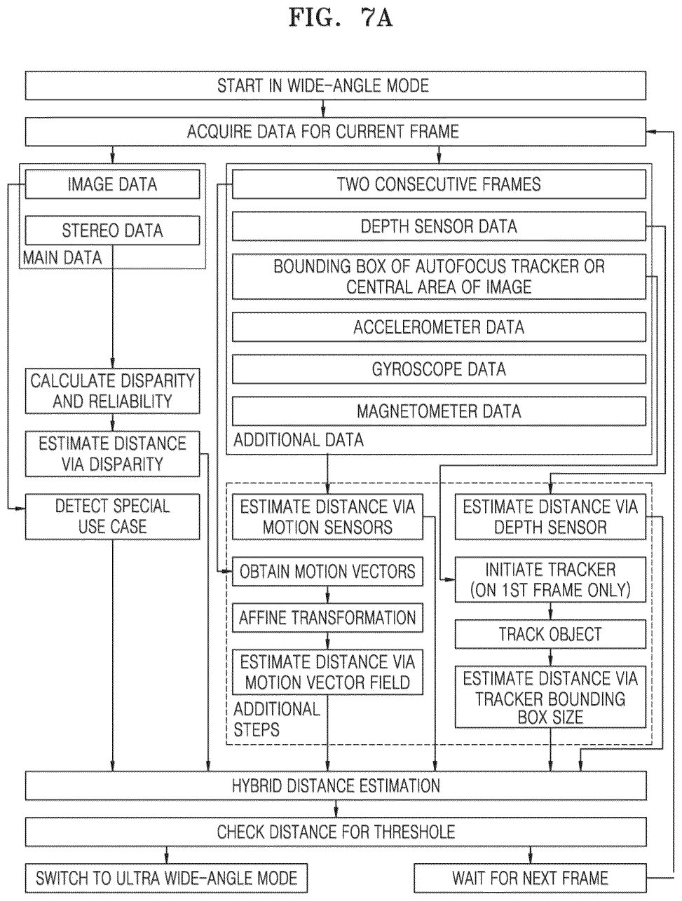

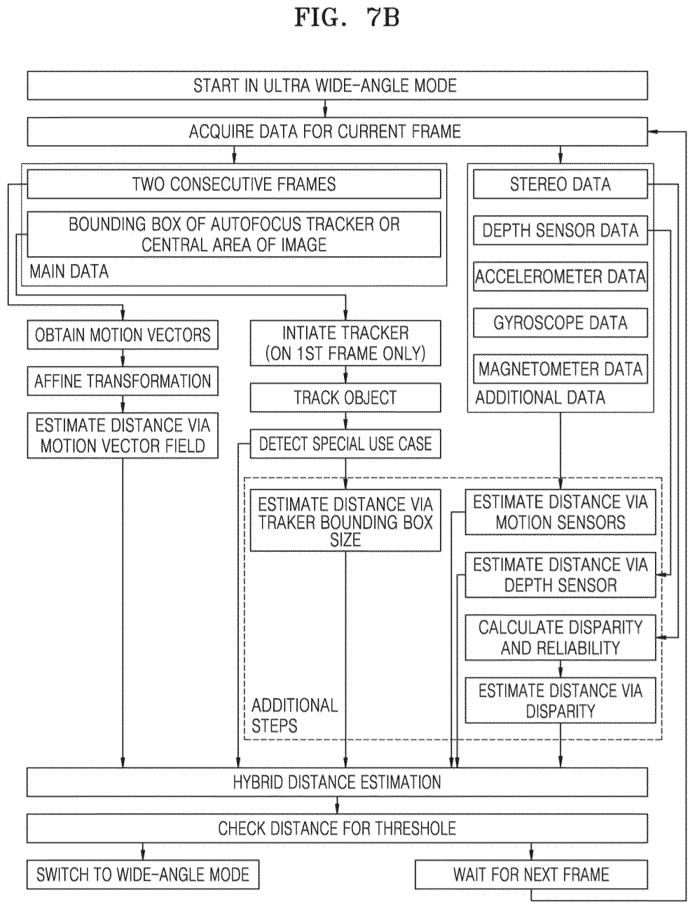

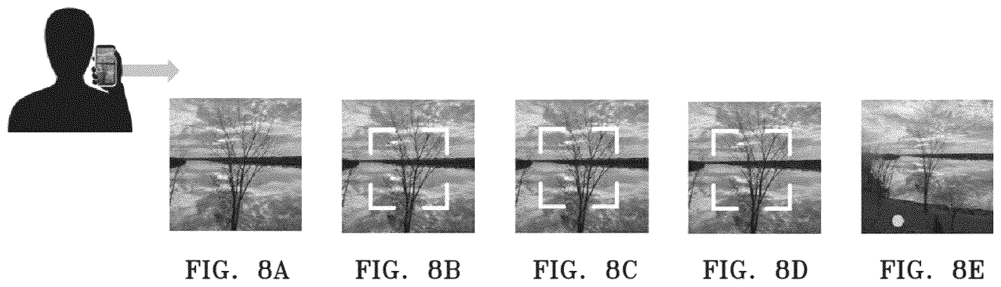

FIG. 7A, 7B shows flowcharts of automatic camera transition, and FIG. 8A-8E shows images on the camera, observed by the user when capturing a scene and/or an object, corresponding to the flowcharts of FIG. 7A, 7B.

Hereinafter, pipeline of automatic camera transition will be disclosed in more detail with reference to FIG. 7A, 7B, and corresponding FIG. 8A-8E:

1) Smartphone user starts camera application, in which Ultra Wide mode of the camera can be selected by default or set by the user. Optionally, the user can manually select an object of interest by tapping appropriate area on the screen, e.g. of the smartphone. Using data from the smartphone camera, the image and its stereo data are formed. By way of example, and not limitation, stereo data can be received from PDAF sensors on Dual Pixel camera array.

It should be noted that it is not necessary to start the camera application in Ultra Wide mode, the user can be in Wide mode if the last mode settings were saved on Wide mode.

FIG. 8A shows the input operation at which the user starts camera in Ultra Wide mode.

2) Construction of a motion vector field based on acquired data and estimation of disparity and reliability.

FIG. 8B shows automatic estimation of motion on the scene, as seen by the user on the camera.

3) Estimation of distance via motion vectors and estimation of distance via stereo data, where special or predetermined use cases can be detected, also from the obtained data, for more stable operation and better user experience. By the user choice and with appropriate sensors integrated in the smartphone or similar device, distance estimation can be performed on the basis of additional motion data on the scene, acquired from a gyroscope, accelerometer, magnetometer, or any other sensor (see FIG. 7A, FIG. 7B)

It should be noted that distance estimation can be performed by various conventional methods, for example, using motion vectors, stereo data, motion sensor data, depth sensor data, data acquired from a tracking algorithm, where different types of data are used. And all distance estimates that can be obtained in Operation 3 are combined into one distance estimate in Operation 4 using a hybrid distance estimate.

FIG. 8C shows automatic distance-to-object estimation observed by the camera user.

4) Next, hybrid distance estimation is performed, which will be described in more detail later and which involves analysis of the estimates and calculations obtained in Operations 2 and 3.

5) Using the object distance data obtained in operation 4 of hybrid distance estimation, lens selection thresholds are checked. Based on this check and analysis of boundary cases, a lens is selected for Ultra Wide mode or Wide mode, and automatic camera transition is performed.

FIG. 8E shows a picture seen by the user at camera transition.

Further described is the hybrid algorithm mentioned with reference to FIG. 8C and FIG. 7A, 7B, which is used for automatic distance-to-object estimation, as seen by the camera user.

Key Point 1: Hybrid Distance Estimation for Determining Distance to Object (see FIG. 7A, FIG. 7B).

1) Being in Ultra Wide (wide-angle) mode, the user starts the camera application to acquire image data from the current frame (images can be color-space encoded, such as RGB, YUV or CMYK) and stereo data, for example, PDAF data or matched image data from two cameras based on object capture.

2) Distance to the object is determined using stereo data. Methods and means for distance estimation using stereo data are disclosed in the document:
[7] RU2778355C2, publication date 17 Aug. 2022, SAMSUNG ELECTRONICS CO., LTD., KR.

3) Based on the acquired object image data, tracking of the object by a tracker is initiated, and the resulting tracking data is used to determine scaling factor of the tracker bounding box between consecutive frames of the captured object image. Using the scaling factor, distance to the object is calculated. The obtained tracking data is also used to detect some boundary cases, such as loss of the object in the frame. The object tracking process is described in detail in patent [7] RU2778355C2, publication date 17 Aug. 2022, belonging to the same patentee (SAMSUNG ELECTRONICS CO., LTD., KR) as the present disclosure.

4) Using two consecutive images from the camera, a motion estimation process is initiated, which is also used to determine the scaling factor between consecutive frames of the captured object image. Motion estimation process is described in the publications:
[8] Pesquet-Popescu, B., Cagnazzo, M., & Dufaux, F. (2013). Motion Estimation Techniques;
[9] Qian, Xueming. (2012). Global Motion Estimation and Its Applications. 10.5772/34166.

Using the scaling factor, distance to the object is calculated.

In this case, scaling factor is calculated through estimation of motion vectors, e.g. as disclosed in the publication:
[10] Lai, Lijun & Xu, Zhiyong. (2015). Global Motion Estimation Based on Fourier Mellin and Phase Correlation. 10.2991/cmes-15.2015.173.

5) Other data and methods may be used to determine distance to the object.

As a non-limiting example, PDAF data, motion and depth sensor data can also be used.

6) Special use cases are detected, which will be described later.

7) Reliability is calculated as

$$R = 100 {x}^{\frac{{Y}_{S}}{{Y}_{N}}} , \qquad ( 1 )$$

where Y_{S} is the signal level, Y_{N} is the noise level for each distance-to-object estimation method used.

8) Use of hybrid distance estimate in the final distance-to-object estimate involves inclusion of data obtained in Operations 2)-7). However, existing similar devices use only one source, i.e. only image data, or only stereo data to estimate distance to the object, therefore, errors may appear in the distance-to-object estimate and, accordingly, in cameras transition.

An embodiment uses several methods to estimate distance to object of interest. For example: tracking the object can be performed using motion vectors on the scene with the object, using PDAF data. All these estimates and their reliabilities are accumulated into a single, more accurate distance-to-object estimate, ensuring precise camera transition even if depth sensors are missing. Depth sensors and other sensors (such as motion data sensors) can also be used for hybrid estimation to further enhance the decision accuracy when such sensors are available.

According to the first embodiment, the hybrid algorithm for distance-to-object estimation described above with reference to FIG. 7A, FIG. 7B may also include input of data from various types of sensors, for example, an accelerometer, gyroscope, magnetometer.

Motion data is acquired from measurements received from various types of sensors, such as accelerometers, gyroscopes, magnetometers, as well as various depth sensors, in particular, based on radio waves (RADAR), on measuring distances by emitting laser light and measuring the time of flight (ToF) sensors or lidars (LiDAR)), or ultra wideband (UWB) sensors using ultra wideband signals in the range of from 6 to 8 GHz.

Using motion data from various sensors, distance to the object is determined and entered into the hybrid algorithm for final distance-to-object estimate.

Flexibility of the first embodiment makes it possible to incorporate various motion data from various sensors (e.g. accelerometer, gyroscope, ToF, LiDAR or UWB). It should be noted that in the present method, separate distance-to-object estimate can be calculated for each data source. Data of motion sensors can be used altogether or separately. On their basis, a distance-to-object estimate can be obtained and converted together with other estimates, for example, based on depth data from depth sensors, into a common single estimate via hybrid distance-to-object estimate. Reliability estimates, which will be described in more detail hereinafter, play a key role in hybrid estimation, allowing different distance estimates to be combined into a single one and thereby provide a more precise estimate of object motion in the scene, and ensure more accurate camera transition.

Key Point 2: Handling Special (Predetermined) Camera Use Case.

1) User starts a camera application: Ultra Wide mode (wide-angle mode) (see FIG. 7A) or Wide mode (ultra wide-angle mode) (see FIG. 7B) through which image data, such as RGB, YUV or CMYK, and stereo data, such as PDAF or matched image data from two cameras, is obtained from the object captured.

2) Disparity and reliability for a frame of selected regions of interest (ROIs) are estimated from stereo data.

3) Camera lens position is determined from the obtained disparity and reliability of selected ROIs.

4) Based on the acquired image data of the object, the process of tracking the object by the tracker is initiated.

5) Motion vectors in the scene with the object are determined from the acquired image data of consecutive frames.

6) Special use cases are detected by analysis of the data obtained in operations 2 to 6 of Key Point 2. For example, the tracker detected object loss in the frame, the decision may be taken to switch from Wide mode to Ultra Wide. Also, disparity and reliability information acquired from stereo data and the image itself can be used to recognize the scene, identify the object of interest and the background (not the object). For example, if no object is detected (plain background), the decision can be taken not to switch from Ultra Wide mode to Wide.

It should be noted that conventional methods of processing distance-to-object data do not identify special use cases, for example, capture of a scene with object through a window glass or a shop window, etc., while the sensors erroneously recognize glass as an object, thereby initiating incorrect camera transition and impairing quality of the image captured by the camera.

The ability to detect special (predetermined) use cases for automatic camera transition enhances precision of object motion estimation in the scene, precision of object distance estimation, and provides better user experience. The use of only image data for processing special use cases makes expensive hardware (e.g. motion sensors) unnecessary.

Use of the method and device for automatic transition between smartphone camera modes provides multiple advantages.

### General Advantages

precise automatic transition between Wide and Ultra Wide modes;
lightweight, compact device suitable for both high-end and mass-market devices.

Advantages of hybrid data processing for distance-to-object estimation (Key Point 1):
multiple sources of distance information used for precise distance-to-object estimation;
consistent camera transition;
present method and device suitable for mass-market.

Advantages of incorporating sensor data into hybrid data processing for distance-to-object estimation (Key Point 1, embodiment 1):
flexibility that enables easy incorporation of depth data from other sources of information;
ability of better performance for high-end devices.

Advantages of special use case processing (Key Point 2):
enhanced accuracy of device operation in special use cases;
lower power consumption due to fast detection of special (predetermined) use cases and separate processing thereof.

In addition, the inventors made an analysis of particular performance parameters of flagship solutions in the market and of the embodiments, which clearly demonstrated the advantage of the present device and method for automatically camera transition.

Main performance characteristics chosen for analysis include: running time, power consumption, successful transitions, %, unwanted transitions, %, delayed transitions, %, and unstable transition distance, %.

### The Embodiments

1) running time ˜9 ms,
2) power consumption 60 mA,
3) successful transitions ˜97%,
4) unwanted transitions ˜0%,
5) delayed transitions ˜2%,
6) unstable transition distance ˜1%.
   U.S. Pat. No. 10,291,842B2 (US20160381289A1) (Patentee Samsung Electronics Co Ltd), Galaxy S21ULTRA Model:
1) running time ˜15 ms,
2) power consumption 54 mA,
3) successful transitions ˜60%,
4) unwanted transitions 31%,
5) delayed transitions ˜8%,
6) unstable transition distance ˜1%.
   US20160007008A1 (Patentee Apple Inc.), iPhone 13 Pro Max Model:
1) N/A (no publicly available data)
2) N/A,
3) user needs to initiate camera transition,
3) successful transitions 27%,
4) unwanted transitions 33%,
5) delayed transitions ˜7%,
6) unstable transition distance ˜33%.

### WO2020073959A1 (Patentee Huawei Technologies Co Ltd.), Model P50Pro:

1) N/A,
2) N/A,
3) successful transitions 97%,
4) unwanted transitions 15%,
5) delayed transitions ˜66%,
6) unstable transition distance ˜66%.

The above analysis of performance characteristics of smartphones in the market clearly demonstrates advantages of the present method and device for automatic camera transition.

Furthermore, the inventors made an analysis of specific functionalities of flagship solutions in the market and of the embodiments, which clearly demonstrated the advantage of the present device and method for automatic camera transition.

Main functionalities chosen for analysis include: motion sensor required, transition scheme, automatic transition, solves delayed transition, solves unwanted transition, solves unstable behavior in special use cases.

### The Embodiments

1) motion sensor not required,
2) Ultra Wide to Wide and vice versa transition,
3) automatic transition,
4) solves delayed transition,
5) solves unwanted transition,
6) solves unstable behavior in special use cases.
   U.S. Pat. No. 10,291,842B2 (US20160381289A1) (Patentee Samsung Electronics Co Ltd), Galaxy S21ULTRA model:
1) motion sensor required,
2) Ultra Wide to Wide and vice versa transition,
3) automatic transition,
4) doesn't solve delayed transition,
5) doesn't solve unwanted transition,
6) doesn't solve unstable behavior in special use cases.
   US20160007008A1 (Patentee Apple Inc.), iPhone 13 Pro Max Model:
1) motion sensor required,
2) Ultra Wide to Wide and vice versa transition,
3) automatic transition,
4) doesn't solve delayed transition,
5) doesn't solve unwanted transition,
6) doesn't solve unstable behavior in special use cases.

### WO2020073959A1 (Patentee Huawei Technologies Co Ltd.), Model P50Pro:

1) motion sensor required,
2) Ultra Wide to Wide and vice versa transition,
3) automatic transition,
4) doesn't solve delayed transition,
5) doesn't solve unwanted transition,
6) doesn't solve unstable behavior in special use cases.

The above analysis of functionalities of existing smartphones clearly demonstrates advantages of the present method and device for automatic transition between operation modes of a camera, for example, of a smartphone.

Next, main key points of the method and device for automatic camera transition will be described. As mentioned earlier, within the scope of the disclosure, the ability of automatic camera transition from Ultra Wide to Wide and vice versa is considered.

When camera is in Ultra Wide mode (wide-angle mode), see FIG. 7A, the following operations are performed:

When capturing an image of a scene with an object of interest in Ultra Wide mode, data is acquired for current frame, particularly, stereo data of current image of k-th frame, including, for example, PDAF data acquired by PDAF sensor array on Dual Pixel camera or matched image data from two cameras based on the object capture, and, if necessary, image data. Each frame of the obtained image is considered as pixels or a group of pixels. Optionally, data is acquired from depth sensors and/or motion sensors.

Based on the acquired stereo data, using the left and right images from a Dual Pixel camera or another pair of images, e.g. from a stereo camera, disparity is estimated by calculating from SAD (Sum of Absolute Differences) curves between the left and right images for the captured scene with the object, obtained by the camera.

It should be noted that to estimate disparity (Dₖ) for the selected object for the k-th frame from the acquired PDAF data representing the right and left images of the object, acquired by the camera sensor array, the sum of absolute differences is calculated as absolute difference between pixels of the left and right image, on the basis of which SAD curves are built. Formally, disparity is a local minimum point on SAD curve, therefore, it is measured in number of pixels. Furthermore, SAD curve is a curve on 2D graph: the X axis corresponds to the shift in the number of pixels of the left image relative to the right one, the Y axis corresponds to respective sum of pixel-by-pixel differences between images for selected patch; the inventors obtained SAD curves using sensors built into a smartphone, which are referred to as “dual pixels” and contain information about two pictures (left and right image of the object from the phone with a slight shift).

Estimation of disparity through stereo reconstruction is described in the following publications:
[11] Raajan N, Ramkumar M, Monisha B, Jaiseeli C, venkatesan SP (2012) Disparity estimation from stereo images. In: International conference on modelling optimization and computing, Springer, vol 38, pp 462-472;
[12] S. Mukherjee and R. M. R. Guddeti, “A hybrid algorithm for disparity calculation from sparse disparity estimates based on stereo vision,” in Proceedings of IEEE International Conference on Signal Processing and Communications (SPCOM), (IEEE, 2014), pp. 1-6.

Based on the obtained SAD curves, reliability R₁ of obtained disparity Dₖ for the captured object for k-th frame is estimated.

With regard to the disclosure, signal-to-noise ratio can be approximated using two minimum values of SAD curve—global minimum and sub-minimum, based on the aforementioned, reliability R₁ is determined as:

$${R}_{1} = 100 \times \frac{{Y}_{S}}{{V}_{N}} ≅ \frac{{Y}_{sub} - {Y}_{min}}{{Y}_{min}} , \qquad ( 2 )$$

where Y_{S} is the signal level, Yₙ is the noise level, Yₘᵢₙ is the global minimum and Y_{sub} is the sub-minimum. Formula (2) defines signal-to-noise ratio approximation using the global minimum and the sub-minimum of the SAD-curve.

The data processing proceeds, and distance d₁ to the object captured by the camera is determined from the acquired stereo data.

Optionally:
Image data of at least two consecutive image frames are compared, and based on the comparison of the image data, field of motion vectors mv_{i,j} is calculated on the scene including the object captured by the camera. Central region of the calculated field of vectors mv_{i,j} is selected, to which affine transformation model is applied, and shift, rotation, and scaling factors are calculated. All the factors are calculated simultaneously. Basic principles of affine transformation are disclosed in the document:
[13] I. M. Vinogradov. Affine transformation//Mathematical encyclopedia.—M.: Soviet Encyclopedia.—1977-1985.

Each vector mv_{i,j} shows movement of one point from frame to frame, i.e. (xₖ, yₖ) are the coordinates of vector origin on analyzed frame k, and (xₖ₊₁, yₖ₊₁) are the coordinates of vector end in frame k+1. Here (A i,j) are traversal indices over the field of vectors, i.e. vectors from multiple points on one frame. Vector mv_{i,j} describes transition from the vector origin with coordinates (xₖ, yₖ) in current frame k to the vector end with coordinates (xₖ₊₁, yₖ₊₁) in the next frame k+1 (i.e. vector mv_{i,j} as such). In matrix form for one pair of coordinates (xₖ, yₖ)→(xₖ₊₁, yₖ₊₁) affine transformation looks as:

$$\begin{matrix}{{Q}_{k}}_{↓} \\ ( \begin{matrix}{x}_{k + 1} \\ {y}_{k + 1}\end{matrix} ) =\end{matrix} \begin{matrix}{{P}_{k}}_{↘} \\ ( \begin{matrix}{x}_{k} & {y}_{k} & 1 & 0 & 0 & 0 \\ 0 & 0 & 0 & {x}_{k} & {y}_{k} & 1\end{matrix} ) \times \end{matrix} \begin{matrix}{A}_{↘} \\ ( \begin{matrix}{a}_{1} \\ {a}_{2} \\ {a}_{3} \\ {a}_{4} \\ {a}_{5} \\ {a}_{6}\end{matrix} )\end{matrix} \qquad ( 3 )$$

It means that affine transformation is an equation of the form Qₖ=PₖA (4) for each vector from the region, where Qₖ, Pₖ and A are components in matrix form, characterizing vectors in current and subsequent frames k and k+1, respectively. Shift, rotation and scaling factors are determined from combinations of desired roots of the equation a₁, a₂, a₃, a₄, a₅, a₆ where a₁, a₂, a₃, a₄, a₅, a₆ are values of matrix A.

They are calculated by the method of least squares (LSM)—the search for roots by minimizing the sum of squared differences between the left and right sides of equations for each vector, i.e. minimization of function ƒ(A) in matrix form, where matrix A=(a₁, a₂, a₃, a₄, a₅, a₆):

$$f ( A ) = {\sum }_{k} {‖ {Q}_{k} - {P}_{K} * A ‖}^{2} \qquad ( 4 )$$

$$Expand : f ( A ) = {\sum }_{k} {( {Q}_{k} - {P}_{K} * A )}^{T} ( {Q}_{k} - {P}_{K} * A ) \qquad ( 5 )$$

For minimization, function gradient grad ƒ should be equated to 0.

$$grad f = {\sum }_{k} ( 0 - 2 * {Q}_{k}^{T} {P}_{k} + 2 * {P}_{k}^{T} {P}_{k} * A ) = 0 \qquad ( 6 )$$

A new matrix equation is obtained: ΣₖPₖ^{T}Pₖ*A=ΣₖQₖ^{T}Pₖ (7). Finally, the roots of the equation (matrix A coefficients) can be found using the Gaussian method. Here, k denotes the current frame, and T is the transposed matrix.

### Example for Matrix

A=(a₁, a₂, a₃, a₄, a₅, a₆)=(1.05, 0.01, −7.82, 0.01, 1.04, −2.56), desired coordinate transformation:

$${x}_{k + 1} = 1.05 {x}_{k} + 0.01 {y}_{k} - 7.82 {y}_{k + 1} = 0.01 {x}_{k} + 1.04 {y}_{k} - 2.56 \qquad ( 8 )$$

Values a₃, a₆ are responsible for shift of current frame along the X and Y axes, respectively, relative to the previous frame. Values a₁, a₅ are responsible for scale change, the scale change factor being calculated as:

ScaleChangeₖ₊₁=ScaleChangeₖ*max(a₁,a₅) (9),

where
ScaleChangeₖ₊₁ is the scale change factor for frame k+1,
ScaleChangeₖ is the scale change factor for current frame k,
max(α₁, α₅) is the maximum value from α₁ and α₅.

Value a₂ is responsible for horizontal stretching of the object in the frame (shear mapping) (e.g. transformation of square into parallelogram), and is considered as obviously absent.

Also, using the affine transformation model, rotation factor is calculated. The affine model considers rotation of points in the frame around the frame center, for example, rotation of point (x, y) by a rotation angle θ in radians. Thus, rotation angle θ from our coordinate transformation can be calculated as:

$$θ = - arc tg ( \frac{{a}_{4}}{{a}_{1}} ) , \qquad ( 10 )$$

where
α₁, α₄ are respective values of matrix A.
   Distance d₂ from camera to the object is determined via the calculated scale change factor, in the current frame k it is calculated as:

$${d}_{2}^{k} = {d}_{2}^{0} / {ScaleChange}_{k} , \qquad ( 11 )$$

where d₂⁰ is the initial distance from camera to the object when switching to Wide mode.

It should be noted that Ultra Wide to Wide transition is carried out upon reaching threshold K, which is predetermined depending on the type of camera used, the inventors selected threshold of 30 cm, as example, this distance is the initial distance for Wide mode, but this value is given only as an example, and may vary.
Reliability R₂ of camera-to-object distance d₂ is determined.

For example, reliability R₂ can be estimated as:

$${R}_{2} = max ( min ( \sum \vert length ( {mv}_{i , j} ) \vert / N * avg\_magnitude \_bound ) \vert , 1 ) - c 1 \_threshold , 0 ) , \qquad ( 12 )$$

where N is the total number of motion vectors (mv_{i,j}), length (mv_{i,j}) is the length of vector mv_{i,j}, avg_magnitude_bound is set manually as the average length parameter of vectors from the vector field, R₂_threshold is set manually as or the minimum allowable reliability parameter. Thus, anomalously long vectors lead to a low reliability, which is consistent with the inventor's subtask of frame-by-frame estimation of object scale change.
Camera-to-object distance d₃ is estimated based on depth data from depth sensors,
Reliability R₃ of distance d₃ is estimated based on depth data from depth sensors,

Since depth and motion sensors are used to estimate reliabilities R₃ and R₄ for distances d₃ and d₄, respectively, their readings can be directly estimated as the signal/noise ratio using expression (1) presented above.

In particular, estimation of reliability R₃ can be performed in the manner described in the publication:
[3] J. Zhu, L. Wang, R. Yang, J. E. Davis and Z. pan, “Reliability Fusion of Time-of-Flight Depth and Stereo Geometry for High Quality Depth Maps,” in IEEE Transactions on Pattern Analysis and Machine Intelligence, vol. 33, no. 7, pp. 1400-1414, July 2011, doi: 10.1109/TPAMI.2010.172.
   Camera-to-object distance d₄ is estimated based on motion sensor data according to expression (1). Reliability R₄ of distance d₄ is estimated based on motion sensor data, as disclosed in the publications:
[14] Terra, R., Figueiredo, L., Barbosa, R. S., & Anacleto, R. (2014). Traveled Distance Estimation Algorithm for Indoor Localization. Procedia Technology, 17, 248-255.
[15] Shi, Yonglei & Fang, Liqing & Guo, Deqing & Qi, Ziyuan & Wang, Jinye & Che, Jinli. (2021). Research on distance measurement method based on micro-accelerometer. AIP Advances. 11. 055126. 10.1063/5.0054463.

Reliability R₄ can be estimated in the manner described in the following documents (sensors are combined under the name IMU (Inertial Measurement Unit), can be calculated through RMSE), as disclosed in the publication:
[16] Cho Y S, Jang S H, Cho J S, Kim M J, Lee H D, Lee S Y, Moon S B. Evaluation of Validity and Reliability of Inertial Measurement Unit-Based Gait Analysis Systems. Ann Rehabil Med. 2018 December; 42 (6): 872-883. doi: 10.5535/arm.2018.42.6.872. publication date 2018 Dec. 28. PMID: 30613081; PMCID: PMC6325313.
   Tracker is initiated for the object only in the first frame (initial) based on a bounding box on the camera screen and the object is tracked on subsequent frames, and scaling factor of the bounding box containing the object is calculated,
   Camera-to-object distance d₅ is estimated via the calculated scaling factor of the bounding box containing the object upon initiating the tracker,
   Reliability R₅ of camera-to-object distance d₅ is estimated via the calculated scaling factor of the bounding box containing the object upon initiating the tracker.

For example, reliability R₅ is estimated as:

$${R}_{5} = ( \frac{+ ( 1 - )}{2} + ) / 3 \qquad ( 13 )$$

In each frame, the tracker first specifies a set of key points to track, in our case for optimization purposes the set is evenly distributed over the bounding box in the form of 2D grid nodes.

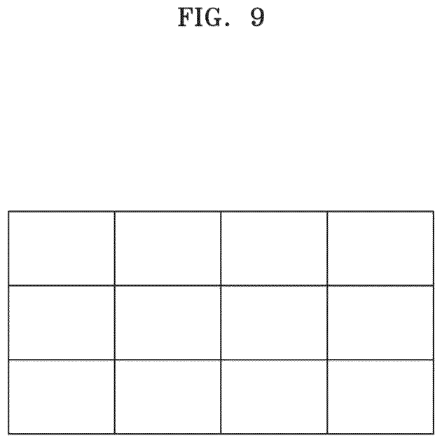

FIG. 9 shows an example of a bounding box in the form of 2D grid nodes.

The tracker then uses optical flow for tracking each point. Thus, a set of predicted vectors is obtained. Final result (scale change, shift) is derived through a “voting” procedure taking into account each vector.

It should be noted that methods and operations for reliability estimation upon initiating a tracker are disclosed in more detail in the publication:
[17] Z. Kalal, K. Mikolajczyk and J. Matas, “Forward-Backward Error: Automatic Detection of Tracking Failures,” 2010 20th International Conference on Pattern Recognition, Istanbul, Turkey, 2010, pp. 2756-2759, doi: 10.1109/ICPR.2010.675.

Further, the description, parameters for obtaining expression (13) are only briefly described, as already mentioned, they are disclosed in detail in the publication [17]:
where: NCC_coeff are the normalized cross-correlation coefficients. This is a measure of image patch similarity. For each vector, it is calculated for a pair of patches (corresponding to the bounding box in the frame, see FIG. 9) from image i and image i+1 with shifted center according to vector mv_{i,j}. Similarity is calculated for each pair of patches obtained from one of motion vectors mv_{i,j}. The median over all values of the image patch similarity is taken as the final estimate.

FB_err is the forward-backward tracking error: the tracker is applied to each key point at transition from frame k to frame k+1 (forward tracking). To calculate the error, the tracker is to be applied to image frames in backward order, using the forward tracking points as key starting points. As a result, the distance between the forward tracking start point and the backward tracking end point determines the error. Final value is calculated from the median of all error values for each key point

“good_point_fraction” is the fraction of initial key points after filtering. Filtering occurs as follows: the above values NCC_coeff and FB_err are calculated for each key point, the points for which the calculation gave values below the threshold (thresholds are known in advance and are set manually as a result of preliminary experiments) are filtered out (not taken into account in the fraction). The filtrating process is described in detail in the publication [17]).

Symbol “\hat{ }” (hat) over each expression denotes normalized value in the range [0,1]. It is obtained each time by comparing with a threshold (set manually). Thus, it is also ensured that R₅ is in the range [0,1]. And if the tracker loses the object, the value of reliability R₅ is set to 0 until the tracker is reinitiated (see publication [17]).

Next, a hybrid estimation of camera-to-object distance in current frame k is performed based on the estimated camera-to-object distances d₁, d₂, d₃, d₄, d₅ and reliabilities R₁, R₂, R₃, R₄, R₅, and updated camera-to-object distance de in the current frame is determined. In this case, the updated distance dₕ is calculated from the expression:

$${d}_{h =} {d}_{1} * {R}_{1} + {d}_{2} * {R}_{2} + {d}_{3} * {R}_{3} + {d}_{4} * {R}_{4} + {d}_{5} * {R}_{5} ; \qquad ( 14 )$$

the decision to switch camera to Wide mode is taken if the obtained updated distance dₕ is less than a predetermined threshold K (for example, 30 cm, but the value may be different). The threshold depends on particular parameters of the camera used to capture the image, i.e. at what distances each of the modes (Wide, Ultra Wide) can focus.

Operations of camera operation in Wide mode (ultra wide-angle mode) will be described with reference to FIG. 7B.

When camera is switched to Wide mode, the following operations are performed.

When an image of a scene with an object of interest is captured in Wide mode of the camera, data is acquired for current frame, i.e. current image data (picture) of k-th frame is provided. Optionally, data from depth sensors and/or data from motion sensors, such as accelerometer, gyroscope, magnetometer is acquired.

Tracking function is initiated and the object is first detected and then tracked; when tracking is initiated, the object is distinguished by a bounding box through the autofocus tracker or through the central region of the image; basic tracker principles are disclosed in detail in the patent:
[7] RU2778355C2, publication date Aug. 17, 2022, belonging to the same patentee (SAMSUNG ELECTRONICS CO., LTD., KR) as the disclosure.

Object can be identified automatically or directly by the user tapping on the screen in the area of the object. Techniques for finding and tracking an object while capturing with a camera are widely known:
[18] Zhang, X Q., Jiang, RH., Fan, C X. et al. Advances in Deep Learning Methods for Visual Tracking: Literature Review and Fundamentals. Int. J. Autom. Comput. 18, 311-333 (2021). https://doi.org/10.1007/s11633-020-1274-8);
[19] Soleimanitaleb, Zahra & Keyvanrad, Mohammad. (2022). Single Object Tracking: A Survey of Methods, Datasets, and Evaluation Metrics;
[20] Luo, Wenhan & Xing, Junliang & Milan, Anton & Zhang, Xiaoqing & Liu, Wei & Zhao, Xiaowei & Kim, Tae-Kyun. (2017). Multiple Object Tracking: A Literature Review. Artificial Intelligence. 293. 10.1016/j.artint.2020.103448.

In Wide mode, a special (predetermined) use case is detected: object loss in the scene captured by the camera, i.e. the object is moving and goes out from the camera field of view.

Thus, if the object is lost in the frame, the camera switches from Wide mode to Ultra Wide mode.

Image data of at least two consecutive frames are compared, and based on the image data comparison, motion vectors mv_{i,j} are obtained for each pixel or group of pixels in the scene including the object. The process of obtaining motion vectors when capturing with a camera is described in detail in the publications:
[21] Heuer, Jörg & Kaup, André. (1999). Global motion estimation in image sequences using robust motion vector field segmentation. 261-264. 10.1145/319463.319620;
[22] Manikandan, M. & Kumar, Vijay & Narayanadass, Ramadass. (2006). Motion estimation method for video compression—An overview. 5 pp.-5. 10.1109/WOCN.2006.1666680.

Update each k frame, where k>1, thus obtaining new motion vectors for each subsequent frame.

Select central region of the calculated field of vectors mv_{i,j}, to which affine transformation model is applied, and shift, rotation, and scaling factors are calculated. All the factors are calculated simultaneously. Example (x, y are the coordinates, k+1 is the current frame, and k is the previous frame):

$${y}_{i + 1} = 0.01 {x}_{i} + 1.04 {y}_{i} - 2.56$$

Camera-to-object distance d₂ is estimated via the calculated scaling factor. The process of estimating camera-to-object distance via motion vectors when capturing with a camera is described in detail in the publication:
[23] Ho, Hann Woei & Croon, Guido & Chu, Q. P. (2017). Distance and velocity estimation using optical flow from a monocular camera. International Journal of Micro Air Vehicles. 9. 198-208. 10.1177/1756829317695566.

Reliability R₂ of camera-to-object distance d₂ is estimated.

For example, reliability R₂ can be calculated as:

$$\\ \begin{matrix}{R}_{2} = max ( min ( \sum \vert length ( {mv}_{i , j} ) \vert / N * avg\_magnitude \_bound ) \vert , 1 ) - c 1 \_threshold , 0 ) ; & ( 12 )\end{matrix}$$

where N is the total number of motion vectors (mv_{i,j}), length (mv_{i,j}) is the length of vector mv_{i,j}, avg_magnitude_bound is set manually as a parameter for average length of vectors from the vector field, R₂_threshold is set manually as a parameter for the minimum allowable reliability.

Or as:

$$\\ {R}_{2} = Error ( ROI ‐ of ‐ image ‐ {frame}_{i + 1} , f ( ROI ‐ of ‐ Image ‐ {frame}_{i} ) ) ,$$

where ƒ is the function that applies scaling and shift calculated using the affine transformation.

Error is the function to calculate the error between image f(Iₖ₋₁) changed by function f in (k−1) th frame and original image Iᵢ in k-th frame.

Optionally:

Estimation of distance to object is performed by the tracker via measuring changes in the size of the tracker's bounding box on the camera screen. Scaling factor of the bounding box enclosing the object is calculated.

Camera-to-object distance d₅ is estimated via the calculated scaling factor of the bounding box containing the object upon initiating the tracker. Distance estimation by a tracker using bounding box is disclosed in the publication:
[24] Vajgl, M.; Hurtik, P.; Nejezchleba, T. Dist-YOLO: Fast Object Detection with Distance Estimation. Appl. Sci. 2022, 12, 1354. https://doi.org/10.3390/app12031354).

Reliability R₅ of camera-to-object distance d₅ is estimated via the calculated scaling factor of the bounding box containing the object upon initiating the tracker.

For example, reliability R₅ is defined as:

$$\\ \begin{matrix}{R}_{5} = ( \frac{+ ( 1 )}{2} + ) / 3 & ( 13 )\end{matrix}$$

In each frame, the tracker first sets a set of key points to track, in our case for optimization purposes the set is evenly distributed over the bounding box in the form of 2D grid nodes.

FIG. 9 shows an example of a bounding box in the form of 2D grid nodes.

The tracker then uses optical flow to track each point. Thus, a set of predicted vectors is obtained. Final result (scale change, shift) is derived through a “voting” procedure, taking into account each vector.

It should be noted that methods and operations for estimating reliability upon initiating the tracer are disclosed in more detail in the aforementioned publication:
[17] Z. Kalal, K. Mikolajczyk and J. Matas, “Forward-Backward Error: Automatic Detection of Tracking Failures,” 2010 20th International Conference on Pattern Recognition, Istanbul, Turkey, 2010, pp. 2756-2759, doi: 10.1109/ICPR.2010.675.

Further, in the description, parameters for obtaining expression (13) are only briefly described, as they are disclosed in detail in the publication [17] as mentioned earlier:

where: NCC_coeff are the normalized cross-correlation coefficients. This is the measure of image patch similarity. For each vector, it is calculated for a pair of patches (corresponding to the bounding box in the frame, see FIG. 9) from image i and image i+1 with a center shifted according to vector mv_{i,j}. Similarity is estimated for each pair of patches obtained from one of motion vectors mv_{i,j}. Median over all of the image patch similarity values is taken as final estimate.

FB_err is the forward-backward tracking error: the tracker is applied for each key point at transition from frame k to frame k+1 (forward tracking). To calculate the error, the tracker should be also applied to the image frames in backward order using the forward tracking points as key start points. As a result, the distance between the forward tracking start point and the backward tracking end point defines the error. Final value is calculated based on the median of all error values for each key point.

“good_point_fraction” is the fraction of initial key points after filtering. Filtering occurs as follows: the above values NCC_coeff FB_err and are calculated for each key point, the points at which the calculation gave values below a threshold (threshold values are known in advance and are set manually as a result of preliminary experiments) are filtered out (not taken into account in the fraction). The filtering process is described in detail in the publication [17].

Symbol “\hat{ }” (hat) over each expression denotes normalized value in the range [0,1]. It is obtained each time by comparison with a threshold (set manually). Thus, it is also ensured that R₅ is in the range [0,1]. And if the tracker loses the object, reliability R₅ is set to 0 until the tracker is reinitiated (see publication [17]).

Optionally:
acquisition of stereo data from the smartphone camera is provided.
disparity Dₖ of the scene including the object captured by the camera is estimated from the acquired stereo data at a given time for each current frame,
reliability R₁ of the estimated disparity Dₖ is estimated from the acquired stereo data,
reliability R₃ of the distance d₃ is estimated from the depth data using depth sensors,
camera-to-object distance d₄ is estimated from the motion sensor data,
reliability R₄ of distance d₄ is estimated from the motion sensor data.

Next, a hybrid estimation of camera-to-object distance in the current frame k is performed based on the estimated camera-to-object distances d₁, d₂, d₃, d₄, d₅ and reliabilities R₁, R₂, R₃, R₄, R₅, and updated camera-to-object distance dₕ in the current frame is determined. Here, updated distance dₕ is calculated from the expression:

$$\\ \begin{matrix}{d}_{h =} {d}_{1} * {R}_{1} + {d}_{2} * {R}_{2} + {d}_{3} * {R}_{3} + {d}_{4} * {R}_{4} + {d}_{5} * {R}_{5} . & ( 14 )\end{matrix}$$

And the decision to switch the camera to Ultra Wide mode is taken if the estimated updated distance dₕ is greater than or equal to a predetermined threshold K (for example, 35 cm, but the value may be different). The threshold depends on specific parameters of the camera used to capture the image, i.e. at what distances each of the modes (Wide, Ultra Wide) can focus.

The value may vary depending on distance settings at which Ultra Wide mode focuses. However, this value should be different from the value for transition to Wide mode, since if the values coincide, the modes would be switched constantly.

Next, a complete pipeline of the method for automatic camera transition from input to output of the result according to the disclosure will be described with reference to FIG. 7A, FIG. 7B showing the method flowchart.

Key Point 1: Hybrid Distance-to-Object Estimation (with reference to FIG. 7A, FIG. 7B).

Input to start the method:
image data (picture), e.g. of a scene containing an object of interest, acquired from a camera integrated in a smartphone or similar device, the image data including:
YUV or RGB, etc. image data for current frame k-th from current Ultra Wide or Wide camera;
image data for previous frames from Wide camera;
stereo data of the image (e.g. from dual pixel camera) or PDAF data of the image from PDAF sensor array of the camera, for current frame in Ultra Wide mode,
optionally, motion data e.g. from a motion sensor, accelerometer or gyroscope, and depth data e.g. from depth sensor,
K, M-thresholds for switching to and from the current mode, i.e. in this case, for switching to Wide mode and Ultra Wide mode, respectively. The thresholds are calculated empirically, based on the range of optimal focal lengths for ultra wide lens and wide lens in the particular camera. As a result of experimental studies and conditions for comfortable observation for the user and based on the selection of optimal values, the following thresholds have been obtained as a non-limiting example: K=30 cm and M=35 cm or K=29 cm and M=32 cm.

The thresholds are not limited to the presented values and are given in this disclosure only as an illustrative example.

### Output of the Present Method:

T∈{Ultra Wide, Wide}—the decision whether to initiate camera transition.

Algorithm of Camera Transition (hybrid algorithm used for camera transition)

### A. Ultra Wide Mode

1. Calculate SAD (Sum of Absolute Differences) curves for the whole scene captured by the camera via stereo data from Ultra Wide mode (SAD curve represents curves on a 2D graph: the X axis corresponds to the shift in the number of pixels of the left image relative to the right one, the Y axis is the respective sum of pixel-by-pixel differences between images for a selected patch; the inventors obtained SAD curves using sensors built into a smartphone, which are called “dual pixels” and contain information about two pictures (left and right images of an object from a phone with a slight shift).

2. Estimate disparity Dₖ via constructed SAD curves (disparity is the local minimum point on the SAD curve).

3. From each SAD curve, extract global minimum and sub-minimum of the SAD curve and other points on the curve and use them to estimate reliability R₁ of the estimated disparity:

$$\\ \begin{matrix}R = 100 \times \frac{{Y}_{S}}{{Y}_{N}} ≅ \frac{{Y}_{sub} - {Y}_{min}}{{Y}_{min}} , & ( 2 )\end{matrix}$$

where Yₛ is the signal level, Yₙ is the noise level, Yₘᵢₙ is the global minimum and Y_{sub} is the sub-minimum. Formula (2) defines approximation of the signal-to-noise ratio using the global minimum and sub-minimum of the SAD curve.

4. Detect special use case, as described in detail in Key Point 2. If no special use case is detected, the method proceeds.

5. Estimate camera-to-object distance d₁ via estimated disparity Dₖ for the current frame (distance estimation via disparity is described in detail in [7] patent RU2778355C2).

6. (Embodiment 1)

Compare image data of at least two consecutive frames, and from the comparison, obtain motion vectors mv_{i,j} for each pixel or group of pixels in the scene including the object captured by the camera. The process of obtaining motion vectors when capturing with a camera is described in detail in the publications:
[21] Heuer, Jörg & Kaup, André. (1999). Global motion estimation in image sequences using robust motion vector field segmentation. 261-264. 10.1145/319463.319620;
[22] Manikandan, M. & Kumar, Vijay & Narayanadass, Ramadass. (2006). Motion estimation method for video compression—An overview. 5 pp.-5. 10.1109/WOCN.2006.1666680.

Update each k frame, where k>1, thus obtaining new motion vectors for each subsequent frame.

Select central region of the calculated vector field mv_{i,j}, to which the affine transformation model described in detail earlier in the present description is applied, and estimate shift, rotation, and scaling factors. All the factors are calculated simultaneously. Example (x, y are the coordinates, k+1 is the current frame, k is the previous frame) for matrix A=(a₁, a₂, a₃, a₄, a₅, a₆)=(1.05, 0.01, −7.82, 0.01, 1.04, −2.56), desired coordinate transformation:

$$\\ \begin{matrix}{x}_{k + 1} = 1.05 {x}_{k} + 0.01 {y}_{k} - 7.82 & ( 8 )\end{matrix}$$

$$\\ {y}_{k + 1} = 0.01 {x}_{k} + 1.04 {y}_{k} - 2.56$$

Estimate camera-to-object distance d₂ via the calculated scaling factor. The process of camera-to-object distance estimation via motion vectors when capturing with a camera is described in detail in the publication:
[23] Ho, Hann Woei & Croon, Guido & Chu, Q. P. (2017). Distance and velocity estimation using optical flow from a monocular camera. International Journal of Micro Air Vehicles. 9. 198-208. 10.1177/1756829317695566.

Estimate distance d₂ and reliability R₂ of the camera-to-object distance d₂ via the calculated scale change factor in the current frame k according to the expression (11) described above.

7. (Embodiment 2) Initiate the tracker for the object of interest using a bounding box on the camera screen, and track the object in subsequent frames, and calculate scaling factor of the bounding box containing the object.

Estimate camera-to-object distance d₅ via the calculated scaling factor of the bounding box containing the object upon initiating the tracker.

Estimate reliability R₅ of the camera-to-object distance d₅ via the calculated scaling factor of the bounding box containing the object upon initiating the tracker using expression (13) above.

8. (Embodiment 3) Estimate camera-to-object distance d₃ via depth data from depth sensors, estimate reliability R₃ of the distance d₃ via depth data from depth sensors.

9. (Embodiment 4) Estimate camera-to-object distance d₄ via motion sensor data, estimate reliability R₄ of the distance d₄ via motion sensor data.

10. Perform hybrid estimation of camera-to-object distance in current frame k based on the estimated camera-to-object distances d₁, d₂, d₃, d₄, d₅ and reliabilities R₁, R₂, R₃, R₄, R₅, and update camera-to-object distance de in the current frame. Here, the updated distance dₕ is calculated from the expression:

$$\\ \begin{matrix}{d}_{h =} {d}_{1} * {R}_{1} + {d}_{2} * {R}_{2} + {d}_{3} * {R}_{3} + {d}_{4} * {R}_{4} + {d}_{5} * {R}_{5} . & ( 14 )\end{matrix}$$

11. Take the decision to switch the camera to Wide mode if the obtained updated distance dₕ is less than a predetermined threshold K (for example, 30 cm, but the value may be different). The threshold depends on particular parameters of the camera used to capture the image, i.e. at what distance each of the modes (Wide, Ultra Wide) can focus.

Key Point 1: Hybrid algorithm for distance-to-object estimation (with reference to FIG. 7A, FIG. 7B).

### Input to Start the Method:

image data e.g. of a scene containing the object of interest and acquired from a camera integrated into a smartphone or similar device, the image data including:
YUV or RGB, etc. image data for current frame k-th acquired from current Ultra Wide or Wide camera;
image data for previous frames acquired from Wide camera;
stereo data of the image (e.g. acquired from Dual Pixel camera) or PDAF data acquired from PDAF sensor array of the device camera for the current frame;
optionally, motion data e.g. from a motion sensor, accelerometer or gyroscope, and depth data e.g. from a depth sensor,
K, M—thresholds for switching to and from the current mode, i.e. in this case, for switching to Wide mode and Ultra Wide mode, respectively. The thresholds are calculated empirically based on the range of optimal focal lengths for Ultra Wide camera lens and Wide camera lens for particular technique used in the camera. As a result of experimental studies and conditions for comfortable observation for the user and based on the selection of optimal values, the following thresholds have been obtained as a non-limiting example: K=30 cm and M=35 cm or K=29 cm and M=32 cm. The thresholds are not limited to the presented values and are given in this disclosure only as an illustrative example.

### Output of the Present Method:

T∈{Ultra Wide, Wide mode}—decision whether to initiate camera transition.

### Algorithm of Camera Transition (Hybrid Transition Algorithm)

### B. Wide Mode

1. Initiate tracking function and first find and then track an object of interest, which is distinguished by a bounding box when tracking is initiated.

Object of interest can be found automatically or directly by user tapping on the screen in the area of the object. Techniques for finding and tracking an object while capturing with a camera are well known from the documents:
[18] Zhang, X Q., Jiang, RH., Fan, C X. et al. Advances in Deep Learning Methods for Visual Tracking: Literature Review and Fundamentals. Int. J. Autom. Comput. 18, 311-333 (2021). https://doi.org/10.1007/s11633-020-1274-8;
[19] Soleimanitaleb, Zahra & Keyvanrad, Mohammad. (2022). Single Object Tracking: A Survey of Methods, Datasets, and Evaluation Metrics;
[20] Luo, Wenhan & Xing, Junliang & Milan, Anton & Zhang, Xiaoqing & Liu, Wei & Zhao, Xiaowei & Kim, Tae-Kyun. (2017). Multiple Object Tracking: A Literature Review. Artificial Intelligence. 293. 10.1016/j.artint.2020.103448.

2. Detect a special use case, as described in detail in Key Point 2. If no special use case to switch to Ultra Wide mode is detected, the method proceeds.

3. Compare image data of at least two consecutive frames and based on the comparison of the image data, obtain motion vectors mv_{i,j} for each pixel or group of pixels in the scene including the object. The process of obtaining motion vectors when capturing with a camera is described in detail in the publications:
[21] Heuer, Jörg & Kaup, André. (1999). Global motion estimation in image sequences using robust motion vector field segmentation. 261-264. 10.1145/319463.319620;
[21] Manikandan, M. & Kumar, Vijay & Narayanadass, Ramadass. (2006). Motion estimation method for video compression—An overview. 5 pp.-5. 10.1109/WOCN.2006.1666680.

4. Update each frame k, where k>1, thus obtaining new motion vectors for each subsequent frame.

5. Select central region of the calculated field of vectors mv_{i,j}, to which the affine transformation model described in detail earlier in this description is applied, and calculate shift, rotation, scaling factors. All the factors are calculated simultaneously. Example (x, y are the coordinates, k+1 is the current frame, k is the previous frame) for matrix A=(a₁, a₂, a₃, a₅, a₅, a₆)=(1.05, 0.01, −7.82, 0.01, 1.04, −2.56) desired coordinate transformation:

$$\\ \begin{matrix}{x}_{k + 1} = 1.05 {x}_{k} + 0.01 {y}_{k} - 7.82 & ( 8 )\end{matrix}$$

$$\\ {y}_{k + 1} = 0.01 {x}_{k} + 1.04 {y}_{k} - 2.56$$

6. Estimate camera-to-object distance d₂ via the calculated scaling factor. The process of camera-to-object distance estimation via motion vectors when capturing with the camera is described in detail in the publication:
[23] Ho, Hann Woei & Croon, Guido & Chu, Q. P. (2017). Distance and velocity estimation using optical flow from a monocular camera. International Journal of Micro Air Vehicles. 9. 198-208. 10.1177/1756829317695566.

7. Estimate distance d₂ and reliability R₂ of the camera-to-object distance d₂ determined via the calculated scale change factor in the current frame k according to the expression (11) described above.

8. (Embodiment 1) Estimate camera-to-object distance d₅ via the calculated scaling factor of the bounding box containing the object upon initiating the tracker according to the expression (13) described above.

9. (Embodiment 2) Calculate SAD (Sum of Absolute Differences) curves for the entire scene captured by the camera from the acquired stereo data (SAD curve comprises curves on the 2D plot: the X axis corresponds to shift in the number of pixels of left image relative to right one, the Y axis corresponds to sum of pixel-by-pixel differences between images for selected patch; the inventors obtain SAD curves using sensors built into smartphone, which are called “dual pixels” and contain information about two pictures (left and right image of the object from phone, smartphone or similar device with a slight shift).

Estimate disparity Dₖ based on the built SAD curves (disparity is the local minimum point on SAD curve).

From each SAD curve, extract minimum values of the SAD curve: global minimum and sub-minimum, and other points of the curve, which are used to estimate reliability R₁ of the calculated disparity:

$$\\ \begin{matrix}R = 100 \times \frac{{Y}_{S}}{{Y}_{N}} ≅ \frac{{Y}_{sub} - {Y}_{min}}{{Y}_{min}} & ( 2 )\end{matrix}$$

where Yₛ is the signal level, Yₙ is the noise level, Yₘᵢₙ is the global minimum and Y_{sub} is the sub-minimum. Formula (1) defines approximation of signal-to-noise ratio using global minimum and sub-minimum of SAD curve.

Estimate camera-to-object distance d₁ via the estimated disparity Dₖ for the current frame (distance estimation via disparity is described in detail in patent [7] RU2778355C2).

10. (Embodiment 3) Estimate camera-to-object distance d₃ via depth data from depth sensors, estimate reliability R₃ of the distance d₃ via depth data from depth sensors.

11. (Embodiment 4) Estimate camera-to-object distance d₄ via motion sensor data, estimate reliability R₄ of the distance d₄ via motion sensor data.

12. Perform hybrid estimation of camera-to-object distance in the current frame k based on the estimated camera-to-object distances d₁, d₂, d₃, d₄, d₅ and reliabilities R₁, R₂, R₃, R₄, R₅, and update camera-to-object distance dₕ in the current frame. Here, the updated distance de is calculated from the expression:

$$\\ \begin{matrix}{d}_{h =} {d}_{1} * {R}_{1} + {d}_{2} * {R}_{2} + {d}_{3} * {R}_{3} + {d}_{4} * {R}_{4} + {d}_{5} * {R}_{5} . & ( 14 )\end{matrix}$$

13. Take the decision to switch the camera from Wide mode to Ultra Wide mode if the obtained updated distance dₕ is greater than predetermined threshold M (for example, 35 cm, but the value may be different). The threshold depends on particular parameters of the camera used to capture the image, i.e. at what distance each of the modes (Wide, Ultra Wide) can focus.

Key Point 2 (with Reference to FIG. 7A, FIG. 7B)

Process special (predetermined) use case. In the operation of detecting special use case of Key Point 1 for Ultra Wide camera, process the special use case.

### Input:

Image Iₖ in frame k

Reliability R₁ and disparity Dₖ from Key Point 1.

Optionally, tracker result (bounding box and presence or absence of the object in frame k).

Optionally, motion vectors (GMV data) from Key Point 1 operations.

Optionally, motion data from e.g. a motion sensor, accelerometer or gyroscope, and depth data from e.g. a depth sensor.

### Output:

Uᵢ—i-th case detected from predetermined use cases U.

### Algorithm of Special Use Case (Processing Algorithm)

### A. Ultra Wide Mode (Wide-Angle Mode) (See FIG. 7A)

1. Calculate function f_{R}(R₁, Dₖ, Iₖ), which depends on the data: reliability R₁, disparity Dₖ, image Iₖ from k-th frame from Key Point 1. Optionally, it can also depend on the data: tracker result (bounding box and presence or absence of object in frame k), motion vectors (GMV data) from Key Point 1, motion data from e.g. a motion sensor, accelerometer or gyroscope, and depth data from e.g. a depth sensor.

In a simple case, function f_{R} can be equal to R₁.

$$\\ {f}_{R} ( {R}_{1} , {D}_{k} , {I}_{k} ) = {R}_{1}$$

Compare result of function f_{R}(R₁, Dₖ, Iₖ) with threshold Rt.

A) if the result of function f_{R}(R₁, Dₖ, Iₖ) exceeds the threshold, i.e. f_{R}(R₁, Dₖ, Iₖ))>Rₜ, conclude that the use case is standard,

B) if the result of function f_{R}(R₁, Dₖ, Iₖ) doesn't exceed the threshold, i.e. f_{R}(R₁, Dₖ, Iₖ)≤Rₜ, conclude that the use case is special, particularly, a case of a non-textured object on plain background, or plain background. For example, capturing a plain wall without a pattern or a table without objects. Threshold Rₜ is selected on the basis of experimental data. For example, if the result of function f_{R}(R₁, Dₖ, Iₖ) is from 0 to 1, Rₜ value could be 0.8.

2. Optionally, in addition to the plain background case, a low light case is also detected using another function f_{R1}(R₁, Dₖ, Iₖ) from the same initial data.

It should be noted that the use of hybrid distance estimate solves distance inaccuracy in the cases of: transparent object, reflective object, object behind glass, low light or a white wall when camera is looking at plain background, local movements of the object with background still, camera rotating or shaking.

3. Continue transition to Key Point 1 operations according to FIG. 7A, FIG. 7B.

Key Point 2 (with Reference to FIG. 7a, FIG. 7b)

Process special (predetermined) use case. In the special use case estimation operation of Key Point 1 (see FIG. 7B), process special use case for Wide camera.

### Input:

Image Iₖ in frame k

Reliability R₅ from Key Point 1

Tracker result (bounding box and presence or absence of bject in frame N)

Optionally, motion vectors (GMV data) from Key Point 1.

Optionally, motion data from e.g. a motion sensor, accelerometer or gyroscope, and depth data from e.g. a depth sensor.

### Output:

Uᵢ—i-th case detected from predetermined use cases U.

### Algorithm of Special Use Case (Processing Algorithm)

### B. Wide Mode (Ultra Wide-Angle) (See FIG. 7B).

1. Initiate object tracking process using bounding box function for object outline.

Defining a bounding box upon initiating object tracking procedures is well known in the art, and can be done: by segmenting the image, selecting a given object of interest manually by the user, initiating at the bounding box center, and disclosed in the publication:
[25] He, Mengqi & Zhang, Jing & Yu, Wenxin. (2022). Salient Object Detection via Bounding-box Supervision.

2. Optionally, automatic tracking function can be used after converting the image (object image) from Ultra Wide image to Wide image, particularly, bounding box in Ultra Wide mode (obtained by tracker available in Ultra Wide mode) is converted to bounding box in Wide mode by a function converting Ultra Wide image to Wide image. An example of automatic object tracking when capturing an image is described in detail in [7] Patent RU2778355C2, publ. Aug. 17, 2022, belonging to the same patent holder (SAMSUNG ELECTRONICS CO., LTD., KR) as the disclosure.

3. Optionally, build a motion vector field and update the motion vector field (GMV data) and tracking data of every frame k, where k>1, thus obtaining new motion vectors for each subsequent frame.

4. Check for object loss while tracking:

The tracker tracks the object. If the bounding box extends completely beyond the frame boundaries, object loss in the current frame is detected. In the case of object loss:

Optionally, check if the scene changed based on the motion vector field.

Optionally, reliability R₅ obtained in Key Point 1 can be used to confirm or disprove object loss.

Optionally, after object loss, hybrid estimate dₕ from Key Point 1 can be additionally checked, if at least one of estimates d₁ and d₃ was used in its calculation.

When the object loss case is confirmed, switch to Ultra Wide mode.

5. Optionally, motion data can be used to detect camera rotation relative to the object.

6. Continue transition to Key Point 1 according to FIG. 7A, 7B.

The disclosure provides the use of a device and a method for camera transition, taking into account the following functionalities:

1) Camera transition process is smooth and precise, and consistent owing to information from multiple sensors used to take the transition decision.

2) Camera transition process is protected from unwanted camera switching and shaking or flickering of images, because the disclosure takes into account appropriate thresholds for switching the camera to Ultra Wide mode and Wide mode.

3) The method and device for automatic camera transition provide stable switching of the camera in predetermined use cases, such as out-of-frame object, low light/white wall effect when camera is looking at plain background, local movements of the object with background still, camera rotating or shaking.

4) The decision to switch camera mode in the disclosure is taken in real time owing to expanded use of various sources of information and high optimization of processes on the obtained data.

5) The solutions implemented in the present method and device for camera transition do not require large computing resources to work on a smartphone.

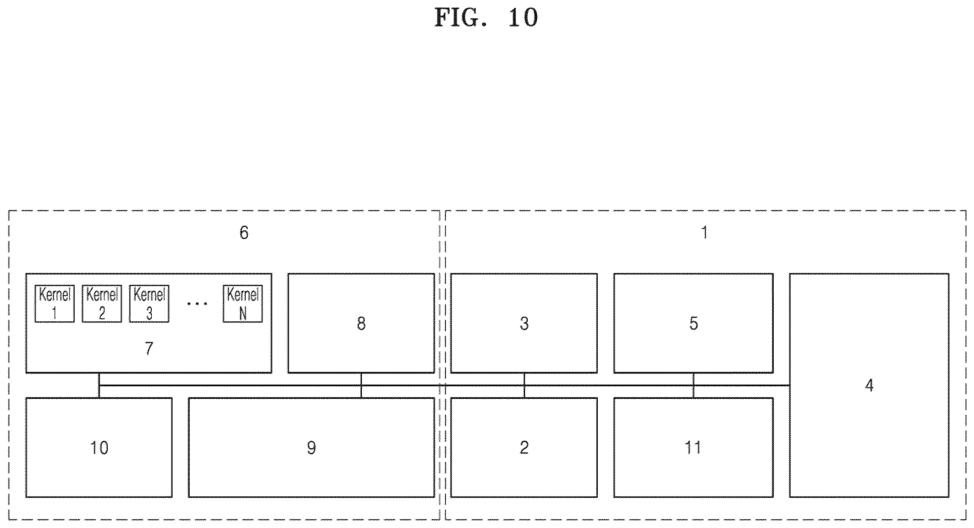

Next, with reference to FIG. 10, an automatic camera transition device, configured to implement operations of the method, will be described. The device comprises:
an input/output (I/O) unit 1 including: a graphics processing unit 2, a display 3, a camera 4, an I/O interface unit 5 including an input interface and an output interface (not shown), and
a computing unit 6 comprising a central processing unit 7, which is a part of a chipset (system on a chip, SoC) and a memory controller 8, a system memory 9 and a storage device 10.

The I/O unit 1 and/or the computing unit 6 may be a part of the processor. The processor may include the The I/O unit 1 and/or the computing unit 6.

The processor may include the graphics processing unit 2, the I/O interface unit 5, the central processing unit 7 and the memory controller 8, but not limited to.

At least one of the graphics processing unit 2, the I/O interface unit 5, the central processing unit 7 or the memory controller 8 may be a part of the processor.

The processor can include one or more processors or other processing devices and execute an operating system stored in the memory in order to control the overall operation of the device.

Furthermore, the camera 4 comprises a multi-camera system including a photo and/or video camera, containing an imaging unit including Wide and Ultra Wide camera lenses, a sensor array, such as a PDAF sensor array providing stereo data when the camera is operating, the camera being configured to capture an object and/or an object scene and transmit image data of the object and/or object scene to the system memory of the computing unit via the I/O interface unit 5. An example of a camera used in this disclosure is described in detail the publications:
[26] A. S. Olagoke, H. Ibrahim and S. S. Teoh, “Literature Survey on Multi-Camera System and Its Application,” in IEEE Access, vol. 8, pp. 172892-172922, 2020, doi: 10.1109/ACCESS.2020.3024568)
[27] US20170082823A1, IPC G02B27/64, publication date 23 Mar. 2017.

The computing unit 6 is configured to calculate distance to the object of interest and/or the object scene and select between Wide and Ultra Wide lens of the camera 4, while the obtained distance and respective lens type (wide-angle or ultra wide-angle lens) are transferred to the system memory 9 and, via the I/O interface unit 5, to the camera 4 for automatic transition of camera operation modes.

The camera 4 is configured to transfer graphic information via the I/O interface unit 5 and the graphics processing unit 2 to the display 3 of the device.

The device display 3 is configured to display the object of interest and/or the object scene in real time.

The I/O unit 1 further comprises motion sensors 11 (accelerometer and/or gyroscope and/or magnetometer) and depth sensors (RaDAR and/or LiDAR and/or ToF sensor and/or UWB sensor).

The graphics processing unit 2 is configured to process graphic information obtained from the device camera 4.

The storage device 10 is configured to store photo and video images captured by the device camera 4 and may be a solid-state drive (SSD).

The device for automatic camera transition according to the disclosure is designed to be integrated into one of: a smartphone, a tablet computer, a photo and video camera.

The device may include at least one memory configured to store instructions and at least one processor configured to execute the instructions stored in the at least one memory.

According to an embodiment, there is provided a method for automatic camera transition between operation modes including:
preliminary capturing an image of a scene including an object of interest to be tracked in one of Wide mode or Ultra Wide mode;
optionally, acquiring data from at least one of: depth sensors, motion sensors;
acquiring at least one of: stereo data, image data in at least two consecutive frames in one of the Wide mode or Ultra Wide mode,

when acquiring stereo data:
estimating disparity Dₖ of the scene including an object of interest, captured by camera, based on the acquired stereo data at a certain instant for each current frame,
estimating reliability R₁ of the estimated disparity Dₖ based on the acquired stereo data,
estimating camera-to-object distance d₁ based on the estimated disparity Dₖ for the current frame;

when acquiring image data:
comparing image data of at least two consecutive frames and, based on the comparison of the image data, calculating field of motion vectors on the scene including the object of interest, captured by the camera,
calculating at least one of a shift factor, a rotation factor, a scene scaling factor, based on the calculated field of motion vectors on the scene,
optionally, initiating a tracker for the object of interest for the current frame, tracking the object in subsequent frames, and calculating scaling factor of camera bounding box containing the object while tracking for each frame,
detecting whether the object is out of frame, and if out-of-frame object is not detected:
estimating camera-to-object distance d₂ using the scaling factor obtained via the calculated motion vector field,
estimating reliability R₂ of the camera-to-object distance d₂,
when acquiring data from depth sensors: estimating camera-to-object distance d₃ via depth data from depth sensors, and estimating reliability R₃ of the distance d₃ via depth data from depth sensors,
when acquiring data from motion sensors: estimating camera-to-object distance d₄ via data from motion sensors and estimating reliability R₄ of the distance d₄ via data from the motion sensors,
when initiating the tracker: estimating camera-to-object distance d₅ via the calculated scaling factor of the bounding box containing the object,
when initiating the tracker: estimating reliability R₅ of the camera-to-object distance d₅ via the calculated scaling factor of the bounding box containing the object, and
performing hybrid estimation of camera-to-object distance in the current frame based on the obtained camera-to-object distances d₁, d₂, d₃, d₄, d₅ and the reliabilities R₁, R₂, R₃, R₄, R₅, and estimating updated camera-to-object distance dₕ in the current frame,
taking a decision whether to switch the camera to Wide mode or to Ultra Wide mode based on the updated distance dₕ.

Furthermore, according to the present method, when the camera is in Ultra Wide mode, if the obtained updated distance dₕ is less than a predetermined threshold, the decision is taken to switch the camera to Wide mode, and when the camera is in Wide mode, if the obtained updated distance dₕ is greater than a predetermined threshold, the decision is taken to switch the camera to Ultra Wide mode.

According to the present method, image data comprises one of: red, green, blue (RGB); luma, chrona (YUV); or cyan, magenta, yellow, key/black (CMYK) data, and stereo data is acquired by phase detection auto focus (PDAF) sensor array of a Dual Pixel camera, wherein
disparity Dₖ for the selected object in the current frame is estimated from PDAF data acquired by the camera sensor array as local minimum of sum of absolute differences (SAD) curve, and the estimating of disparity Dₖ for the selected object in the current frame from the obtained PDAF data representing the right and left image of the object, acquired by the camera sensor array, comprises calculating the sum of absolute differences as absolute difference between pixels of the left and right image, on the basis of which the SAD curves are built.

The present method comprises estimating updated distance dₕ based on the estimated camera-to-object distances d₁, d₂, d₃, d₄, d₅ and reliabilities R₁, R₂, R₃, R₄, R₅ for the current frame according to the expression:

$$\\ {d}_{h =} {d}_{1} * {R}_{1} + {d}_{2} * {R}_{2} + {d}_{3} * {R}_{3} + {d}_{4} * {R}_{4} + {d}_{5} * {R}_{5} .$$

Furthermore, reliability R₁ for the current frame is calculated based on SAD curve data and is estimated from the expression:

$$\\ {R}_{1} = 100 \times \frac{{Y}_{S}}{{Y}_{N}} ≅ \frac{{Y}_{sub} - {Y}_{min}}{{Y}_{min}} ,$$

where Yₛ is the signal level, Yₙ is the noise level, Yₘᵢₙ is the global minimum, and Y_{sub} is the sub-minimum of SAD curve.

Moreover, reliability R₂ for the current frame is estimated based on on vector field data and subsequent affine transformation of the vector field, and reliability R₃ for the current frame defines approximation of the signal-to-noise ratio obtained via depth sensor data, and is estimated from the expression:

$$\\ {R}_{3} = 100 \times \frac{{Y}_{S}}{{Y}_{N}} ,$$

where R₃ is the reliability, Y_{S} is the signal level, and Y_{N} is the noise level.

According to the method, reliability R₄ for the current frame defines approximation of the signal-to-noise ratio obtained from at least one motion sensor data, and is estimated from the expression:

$$\\ {R}_{4} = 100 \times \frac{{Y}_{S}}{{Y}_{N}} ,$$

where R₄ is the reliability, Y_{S} is the signal level, and Y_{N} is the noise level.

Moreover, according to the method, reliability R₅ is estimated from tracker results.

Furthermore, in the present method
camera-to-object distance d₁ is estimated from estimated disparity Dₖ for the current frame,
camera-to-object distance d₂ is determined based on estimated scaling factor for the current frame,
camera-to-object distance d₃ is determined from depth data using depth sensors, and camera-to-object distance d₄ is determined from motion data using motion sensors,
camera-to-object distance d₅ is estimated from scaling factor of the bounding box containing the object.

Furthermore, the method comprises calculating scaling factor of the bounding box on the camera screen, containing the object of interest, for the current frame k as aspect ratio of the bounding box of the current frame and the previous frame.

The method further comprises, optionally, detecting predetermined camera operation cases when capturing the object in the current frame, the cases being related to at least one of: transparent object, reflective object, object behind glass, low light or white wall effect when camera is looking at plain background, local movements of the object with background still, rotating or shaking camera.

When the camera is in Ultra Wide mode or in Wide mode, at least one of shift factor, rotation factor, and scene scaling factor is calculated via affine transformation of the calculated motion vector field of the scene; moreover, when the camera is in Ultra Wide mode, reliability R₂ of camera-to-object distance d₂ is estimated based on the calculated motion vector field of the scene and affine transformation of the vector field.

Moreover, when the camera is in Wide mode, upon initiating the tracker, if the bounding box including the object extends beyond the current frame, object loss is detected in the current frame, and upon detecting object loss in the current frame, the decision is taken to switch the camera to Ultra Wide mode.

Furthermore, after detecting object loss in the current frame, the method comprises: further estimating camera-to-object distance d₁ based on the estimated disparity Dₖ for the current frame, and further estimating camera-to-object distance d₃ from depth data using depth sensors for the current frame after detecting object loss in the current frame.

According to an embodiment, in the method, when the camera is in Wide mode, distance dₕ is further estimated after detecting object loss in the current frame, taking into account the further estimated distance d₁ and/or d₃.

Furthermore, if estimated distance de after detecting object loss in the frame is less than a predetermined threshold, the decision is taken to maintain Wide mode, and proceed to subsequent frame, and if estimated distance dₕ after detecting object loss in the frame is greater than or equal to a predetermined threshold, the decision to switch the camera to Ultra Wide mode is taken.

Furthermore, according to the method, at least one of shift factor, rotation factor, and scaling factor is calculated by applying affine transformation model to the calculated vector field.

According to an embodiment there is provided a device for automatic camera transition between operation modes, including:
an I/O unit including a graphics processing unit, a display, a camera, and I/O interface unit;
a computing unit including a central processing unit, a memory controller, a system memory and a storage device,
wherein the camera is a multi-camera system including a photo and/or video camera, and including an imaging unit containing Wide lens and Ultra Wide lens, and a sensor array, wherein the camera is configured to capture an object of interest and send object image data to the system memory of the computing unit via the I/O interface unit;
the computing unit is configured to execute operations of the method according to an embodiment, and estimate distance to the object, and take a decision whether to switch the camera to Wide mode or to Ultra Wide mode, the estimated distance to the object and the decision to switch the camera being transferred to the system memory and via the I/O interface unit to the camera to switch the camera mode;
the camera is configured to transfer graphic information via the I/O interface unit and the graphics processing unit to the display of the device;
the display is configured to display the object in real time.

Moreover, in the device, the graphics processing unit is configured to process graphics information acquired from the device camera, and the sensor array is a PDAF sensor array; the storage device is configured to store photo and video images captured by the device camera, and comprises a solid-state drive (SSD).

Furthermore, in the device, the I/O unit further comprises at least one motion sensor and depth sensor; the motion sensor is at least one of an accelerometer, a gyroscope, a magnetometer, and the depth sensor is at least one of: radio detection and ranging (RaDAR), light detection and ranging (LiDAR), time of flight (ToF) sensor, and ultra-wideband (UWB) sensor.

Furthermore, the memory controller is configured to transfer data from the system memory to the central processing unit for computing.

The present device is configured to be integrated into one of: a smartphone, a tablet computer, a photo and video camera.

A method for automatic camera transition in a smartphone and other similar devices. The method includes: preliminary capturing an image of a scene including an object of interest to be tracked in one of Wide mode or Ultra Wide mode; optionally, acquiring data from at least one of: depth sensors, motion sensors; acquiring at least one of: stereo data, image data in at least two consecutive frames in one of the Wide mode or Ultra Wide mode, and when acquiring stereo data: estimating disparity Dₖ of the scene including an object of interest, captured by camera, based on the acquired stereo data at a certain instant for each current frame, estimating camera-to-object distance d₁ and reliability R₁ of the estimated disparity Dₖ based on the acquired stereo data.

According to an embodiment of the disclosure, the method, performed by a device, may include obtaining an image of a scene including an object of interest to be tracked in at least one camera mode.

According to an embodiment of the disclosure, the method may include obtaining image data of at least two consecutive frames in the at least one camera mode based on the image.

According to an embodiment of the disclosure, the method may include estimating a disparity and a reliability of the scene including the object of interest based on the image data.

According to an embodiment of the disclosure, the method may include estimating a camera-to-object distance based on the disparity and the reliability.

According to an embodiment of the disclosure, the method may include switching the camera mode based on the camera-to-object distance.

According to an embodiment of the disclosure, the image data may include stereo data.

According to an embodiment of the disclosure, the image data may include a field of at least one motion vector of the object of interest.

According to an embodiment of the disclosure, the method may include obtaining the at least one motion vector of the object of interest based on a comparison of the at least two consecutive frames.

According to an embodiment of the disclosure, the method may include updating the camera-to-object distance based on the at least one motion vector.

According to an embodiment of the disclosure, the method may include switching the camera mode based on the updated camera-to-object distance.

According to an embodiment of the disclosure, the method may include switching the camera mode from an Ultra Wide mode to a Wide mode in case that the camera mode is the Ultra Wide mode and the camera-to-object distance is less than a predetermined threshold.

According to an embodiment of the disclosure, the camera mode may include the Wide mode and the Ultra Wide mode According to an embodiment of the disclosure, the method may include

According to an embodiment of the disclosure, the method may include switching the camera mode from a Wide mode to an Ultra Wide mode in case that the camera mode is the Wide mode and the camera-to-object distance is greater than a predetermined threshold.

According to an embodiment of the disclosure, the method may include tracking the object of interest in subsequent frames.

According to an embodiment of the disclosure, the method may include calculating a scaling factor of a bounding box containing the object of interest while tracking for each frame.

According to an embodiment of the disclosure, the method may include estimating the reliability of the camera-to-object distance based on the scaling factor of the bounding box containing the object of interest.

According to an embodiment of the disclosure, the method may include estimating the camera-to-object distance based on the reliability estimated based on the scaling factor of the bounding box containing the object of interest.

According to an embodiment of the disclosure, the method may include identifying at least one event based on the image data.

According to an embodiment of the disclosure, the method may include switching the camera mode based on the identification.

According to an embodiment of the disclosure, the at least one event may include at least one of a case wherein the object of interest is transparent, a case wherein the object of interest is reflective, a case wherein the object of interest positions behind a glass, a case wherein the object of interest moves while a background is fixed, a case wherein the camera is rotated or a case wherein the camera is shaken.

According to an embodiment of the disclosure, the method may include detecting an object loss in case that the camera mode is a Wide mode and the bounding box including the object of interest extends beyond a current frame.

According to an embodiment of the disclosure, the method may include switching the camera mode from the Wide mode to a Ultra Wide mode based on the object loss.

According to an embodiment of the disclosure, the method may include updating the camera-to-object distance after detecting the object loss in the current frame.

According to an embodiment of the disclosure, the method may include switching the camera mode based on the updated camera-to-object distance.

According to an embodiment of the disclosure, the method may include switching the camera mode from the Wide mode to the Ultra Wide mode in case that the camera mode is the Wide mode and the updated camera-to-object distance is greater than or equal to a predetermined threshold.

According to an embodiment of the disclosure, the method may include maintaining the camera mode in case that the camera mode is the Ultra Wide mode and the updated camera-to-object distance is less than the predetermined threshold.

According to an embodiment of the disclosure, the method may include estimating the camera-to-object distance based on at least one sensor.

According to an embodiment of the disclosure, the device may include at least one camera, at least one memory configured to store instructions and at least one processor configured to execute the instructions.

According to an embodiment of the disclosure, the at least one processor is configured to obtain an image of a scene including an object of interest to be tracked in at least one camera mode via the at least one camera.

According to an embodiment of the disclosure, the at least one processor is configured to obtain image data of at least two consecutive frames in the at least one camera mode based on the image.

According to an embodiment of the disclosure, the at least one processor is configured to estimate a disparity and a reliability of the scene including the object of interest based on the image data.

According to an embodiment of the disclosure, the at least one processor is configured to estimate a camera-to-object distance based on the disparity and the reliability.

According to an embodiment of the disclosure, the at least one processor is configured to switch the camera mode based on the camera-to-object distance.

According to an embodiment of the disclosure, the image data may include stereo data. According to an embodiment of the disclosure, the image data may include a field of at least one motion vector of the object of interest.

According to an embodiment of the disclosure, the at least one processor is configured to obtain the at least one motion vector of the object of interest based on a comparison of the at least two consecutive frames.

According to an embodiment of the disclosure, the at least one processor is configured to update the camera-to-object distance based on the at least one motion vector.

According to an embodiment of the disclosure, the at least one processor is configured to switch the camera mode based on the updated camera-to-object distance.

According to an embodiment of the disclosure, the at least one processor is configured to switch the camera mode from an Ultra Wide mode to a Wide mode in case that the camera mode is the Ultra Wide mode and the camera-to-object distance is less than a predetermined threshold.

According to an embodiment of the disclosure, the camera mode may include the Wide mode and the Ultra Wide mode.

According to an embodiment of the disclosure, the at least one processor is configured to switch the camera mode from a Wide mode to an Ultra Wide mode in case that the camera mode is the Wide mode and the camera-to-object distance is greater than a predetermined threshold.

According to an embodiment of the disclosure, the at least one processor is configured to track the object of interest in subsequent frames.

According to an embodiment of the disclosure, the at least one processor is configured to calculate a scaling factor of a bounding box containing the object of interest while tracking for each frame.

According to an embodiment of the disclosure, the at least one processor is configured to estimate the reliability of the camera-to-object distance based on the scaling factor of the bounding box containing the object of interest.

According to an embodiment of the disclosure, the at least one processor is configured to estimate the camera-to-object distance based on the reliability estimated based on the scaling factor of the bounding box containing the object of interest.

According to an embodiment of the disclosure, the at least one processor is configured to identify at least one event based on the image data.

According to an embodiment of the disclosure, the at least one processor is configured to switch the camera mode based on the identification.

According to an embodiment of the disclosure, the at least one event may include at least one of a case wherein the object of interest is transparent, a case wherein the object of interest is reflective, a case wherein the object of interest positions behind a glass, a case wherein the object of interest moves while a background is fixed, a case wherein the camera is rotated or a case wherein the camera is shaken.

According to an embodiment of the disclosure, the at least one processor is configured to detect an object loss in case that the camera mode is a Wide mode and the bounding box including the object of interest extends beyond a current frame.

According to an embodiment of the disclosure, the at least one processor is configured to switch the camera mode from the Wide mode to a Ultra Wide mode based on the object loss.

According to an embodiment of the disclosure, the at least one processor is configured to update the camera-to-object distance after detecting the object loss in the current frame.

According to an embodiment of the disclosure, the at least one processor is configured to switch the camera mode based on the updated camera-to-object distance.

According to an embodiment of the disclosure, the at least one processor is configured to switch the camera mode from the Wide mode to the Ultra Wide mode in case that the camera mode is a Wide mode and the updated camera-to-object distance is greater than or equal to a predetermined threshold.

According to an embodiment of the disclosure, the at least one processor is configured to maintain the camera mode in case that the camera mode is the Ultra Wide mode and the updated camera-to-object distance is less than the predetermined threshold.

According to an embodiment of the disclosure, the device may further include at least one sensor.

According to an embodiment of the disclosure, the at least one processor is configured to estimate the camera-to-object distance based on at least one sensor.

The device and method for automatic camera transition between operation modes can be used to capture photo and video by smartphone cameras, as well as in tablet computers running Android, IOS, HarmonyOS and similar operating systems, and in other similar devices which need automatic camera transition.

What is claimed is:

1. A method for automatic camera transition between operation modes, comprising:
obtaining an image of a scene including an object of interest to be tracked in at least one camera mode;
obtaining image data of at least two consecutive frames in the at least one camera mode based on the image;
estimating a disparity and a reliability of the scene including the object of interest based on the image data;
estimating a camera-to-object distance based on the disparity and the reliability; and
switching the camera mode based on the camera-to-object distance;
wherein the image data includes stereo data; and
wherein the image data includes a field of at least one motion vector of the object of interest.

2. The method of claim 1, further comprising:
obtaining the at least one motion vector of the object of interest based on a comparison of the at least two consecutive frames;
updating the camera-to-object distance based on the at least one motion vector; and
switching the camera mode based on the updated camera-to-object distance.

3. The method of claim 1, further comprising:
switching the camera mode from an Ultra Wide mode to a Wide mode in case that the camera mode is the Ultra Wide mode and the camera-to-object distance is less than a predetermined threshold;
wherein the camera mode includes the Wide mode and the Ultra Wide mode.

4. The method of claim 1, further comprising:
switching the camera mode from a Wide mode to an Ultra Wide mode in case that the camera mode is the Wide mode and the camera-to-object distance is greater than a predetermined threshold;
wherein the camera mode includes the Wide mode and the Ultra Wide mode.

5. The method of claim 1, further comprising:
tracking the object of interest in subsequent frames;
calculating a scaling factor of a bounding box containing the object of interest while tracking for each frame;
estimating the reliability of the camera-to-object distance based on the scaling factor of the bounding box containing the object of interest; and
estimating the camera-to-object distance based on the reliability estimated based on the scaling factor of the bounding box containing the object of interest.

6. The method of claim 1, further comprising:
identifying at least one event based on the image data; and
switching the camera mode based on the identification;
wherein the at least one event includes at least one of a case wherein the object of interest is transparent, a case wherein the object of interest is reflective, a case wherein the object of interest positions behind a glass, a case wherein the object of interest moves while a background is fixed, a case wherein the camera is rotated or a case wherein the camera is shaken.

7. The method of claim 5, further comprising:
detecting an object loss in case that the camera mode is a Wide mode and the bounding box including the object of interest extends beyond a current frame; and
switching the camera mode from the Wide mode to a Ultra Wide mode based on the object loss.

8. The method of claim 7, further comprising:
updating the camera-to-object distance after detecting the object loss in the current frame; and
switching the camera mode based on the updated camera-to-object distance.

9. The method of claim 8, further comprising:
switching the camera mode from the Wide mode to the Ultra Wide mode in case that the camera mode is the Wide mode and the updated camera-to-object distance is greater than or equal to a predetermined threshold; and
maintaining the camera mode in case that the camera mode is the Ultra Wide mode and the updated camera-to-object distance is less than the predetermined threshold.

10. The method of claim 1, further comprising:
estimating the camera-to-object distance based on at least one sensor.

11. A device comprising:
at least one camera;
at least one memory configured to store instructions; and
at least one processor configured to execute the instructions to:
obtain an image of a scene including an object of interest to be tracked in at least one camera mode via the at least one camera;
obtain image data of at least two consecutive frames in the at least one camera mode based on the image;
estimate a disparity and a reliability of the scene including the object of interest based on the image data;
estimate a camera-to-object distance based on the disparity and the reliability; and
switch the camera mode based on the camera-to-object distance;
wherein the image data includes stereo data; and
wherein the image data includes a field of at least one motion vector of the object of interest.

12. The device of claim 11, wherein the at least one processor is further configured to execute the instructions to:
obtain the at least one motion vector of the object of interest based on a comparison of the at least two consecutive frames;
update the camera-to-object distance based on the at least one motion vector; and
switch the camera mode based on the updated camera-to-object distance.

13. The device of claim 11, wherein the at least one processor is further configured to execute the instructions to:
switch the camera mode from an Ultra Wide mode to a Wide mode in case that the camera mode is the Ultra Wide mode and the camera-to-object distance is less than a predetermined threshold;
wherein the camera mode includes the Wide mode and the Ultra Wide mode.

14. The device of claim 11, wherein the at least one processor is further configured to execute the instructions to:
switch the camera mode from a Wide mode to an Ultra Wide mode in case that the camera mode is the Wide mode and the camera-to-object distance is greater than a predetermined threshold;
wherein the camera mode includes the Wide mode and the Ultra Wide mode.

15. The device of claim 11, wherein the at least one processor is further configured to execute the instructions to:
track the object of interest in subsequent frames;
calculate a scaling factor of a bounding box containing the object of interest while tracking for each frame;
estimate the reliability of the camera-to-object distance based on the scaling factor of the bounding box containing the object of interest; and
estimate the camera-to-object distance based on the reliability estimated based on the scaling factor of the bounding box containing the object of interest.

16. The device of claim 11, wherein the at least one processor is further configured to execute the instructions to:
identify at least one event based on the image data; and
switch the camera mode based on the identification;
wherein the at least one event includes at least one of a case wherein the object of interest is transparent, a case wherein the object of interest is reflective, a case wherein the object of interest positions behind a glass, a case wherein the object of interest moves while a background is fixed, a case wherein the camera is rotated or a case wherein the camera is shaken.

17. The device of claim 15, wherein the at least one processor is further configured to execute the instructions to:
detect an object loss in case that the camera mode is a Wide mode and the bounding box including the object of interest extends beyond a current frame; and
switch the camera mode from the Wide mode to a Ultra Wide mode based on the object loss.

18. The device of claim 17, wherein the at least one processor is further configured to execute the instructions to:
update the camera-to-object distance after detecting the object loss in the current frame; and
switch the camera mode based on the updated camera-to-object distance.

19. The device of claim 18, wherein the at least one processor is further configured to execute the instructions to:
switch the camera mode from the Wide mode to the Ultra Wide mode in case that the camera mode is a Wide mode and the updated camera-to-object distance is greater than or equal to a predetermined threshold; and
maintain the camera mode in case that the camera mode is the Ultra Wide mode and the updated camera-to-object distance is less than the predetermined threshold.

20. The device of claim 11, further comprising:
at least one sensor, and
wherein the at least one processor is further configured to execute the instructions to:
estimate the camera-to-object distance based on the at least one sensor.
